(19) United States
(12) Patent Application Publication
(10) Pub. No.: US 2014/0043680 A1
(43) Pub. Date: Feb. 13, 2014

(54) IMAGE DISPLAY DEVICE WITH ALIGNING UNIT AND MANUFACTURING METHOD THEREOF

(71) Applicants: Shin-ichi UEHARA, Tokyo (JP); Nobuaki TAKANASHI, Tokyo (JP)

(72) Inventors: Shin-ichi UEHARA, Tokyo (JP); Nobuaki TAKANASHI, Tokyo (JP)

(73) Assignee: NLT TECHNOLOGIES, LTD., Kawasaki (JP)

(21) Appl. No.: 14/057,514

(22) Filed: Oct. 18, 2013

Related U.S. Application Data
(62) Division of application No. 13/025,866, filed on Feb. 11, 2011.
Application No. 13/025,866 is a division of application No. 10/787,172, filed on Feb. 27, 2004, now abandoned.

(30) Foreign Application Priority Data
Feb. 28, 2003 (JP) 2003-054437

(51) Int. Cl. G02B 27/22

(52) U.S. Cl. CPC G02B 27/2214
USPC 359/463; 359/477

(57) ABSTRACT

A marker for lens is provided as aligning unit in a lenticular lens of an optical unit, and a marker for display panel is provided as aligning unit in a transmissive liquid crystal display panel of the display panel. A fixing unit is provided in at least a part of an area that encloses an image display area of the lenticular lens. An image display device is formed in such a manner that alignment between the lenticular lens and the liquid crystal display panel is performed by the marker for lens and the marker for display panel and the lenticular lens is fixed to a surface of the liquid crystal display panel on the side of a viewer.

### CROSS REFERENCE TO RELATED APPLICATIONS

This application is a divisional application of Ser. No. 13/025,866 filed Feb. 11, 2011, which is a divisional of U.S. patent application Ser. No. 10/787,172, filed Feb. 27, 2004, which claims priority to Japanese Patent Application No. 2003-054437, filed Feb. 28, 2003, the contents of all of which are incorporated herein by reference.

### BACKGROUND ART OF THE INVENTION

1. Field of the Invention

The present invention relates to an image display device that uses a lens such as a lenticular lens or a fly-eye lens and can display images respectively directed to plural viewpoints and a manufacturing method thereof, particularly to an image display device that has excellent durability and a manufacturing method thereof.

2. Description of the Related Art

Conventionally, a display device that can display a three-dimensional image has been studied. In 280 B.C., Euclid who was a mathematician in Greece considered that binocular vision is a sense which is obtained in such a manner that both a left eye and a right eye of a viewer simultaneously see individual images of the same object viewed from different directions (Chihiro Masuda, “Three-dimensional display”, pp. 1, Sangyo Tosho K.K.). For a function of the three-dimensional image display device, it is necessary that each of the images having parallaxes be independently provided to the left eye and the right eye of the viewer.

In order to realize this function, various kinds of three-dimensional image display methods have been studied. The s three-dimensional image display methods can be broadly divided into the method in which eyeglasses are used and the method in which the eyeglasses are not used. An anaglyph method that utilizes difference in color and a polarized eyeglasses method that utilizes polarization can be cited as an example of the method in which the eyeglasses are used. However, since inconvenience of wearing the eyeglass cannot be essentially avoided, the method in which the eyeglasses are not used is actively studied in recent years.

As the eyeglass-less methods, a lenticular lens method, a parallax barrier method, and the like are known. The parallax barrier method is the three-dimensional image display method in which Berthier thought of the method in 1896 and Ives demonstrated the method in 1903. FIG. 1 is a view of an optical model showing a method of displaying the three-dimensional image by the parallax barrier method. As shown in FIG. 1, a parallax barrier 101 is a barrier (light shield) in which many thin vertical stripe-shaped openings, i.e. many slits 101a are formed. Display panel 102 is arranged in the vicinity of one of surfaces of the parallax barrier 101. In the display panel 102, pixels 102a for left eye and pixels 102b for right eye are arrayed in a direction orthogonal to a longitudinal direction of the slit 101a. A light source (not shown) is arranged in the vicinity of the other surface of the parallax barrier 101, i.e. on an opposite side from the display panel 102.

The light emitted from the light source is partially obstructed by the parallax barrier 101. The light which are not obstructed by the parallax barrier but pass through the slits 101a become light fluxes 103a through the pixels 102a for left eye and become light fluxes 103b through the pixels 102b for right eye. At this point, the pixels 102a for left eye and the pixels 102b for right eye are arranged so that the light fluxes 103a which have passed through the pixels for left eye 102a reach only a left eye 104a of the viewer and the light fluxes 103b which have passed through the pixels for right eye 102b reach only a right eye 104b of the viewer. Thus, the light from the different pixels reach the left eye and the right eye of the viewer respectively, so that the viewer can recognize the image displayed on the display panel 102 as the three-dimensional image.

The above-described parallax barrier method, when it was invented at first, had a problem that the parallax barrier had been an eyesore and caused low visibility because it was arranged between the pixels and the eyes. However, with the achievement of liquid crystal display panels in recent years, it has become possible to arrange the parallax barrier on the rear side of the display panel, and the problem of visibility has been improved. Accordingly, study of the three-dimensional image display device of the parallax barrier method is actively studied.

Meanwhile, the lenticular lens method was invented around 1910 by Ives, et al. as described in the above-described literature (“Three-dimensional display” written by Chihiro Masuda and published by Sangyo Tosho K.K., p. 1). FIG. 2 is a perspective view showing the lenticular lens, and FIG. 3 is a view of the optical model showing the method of displaying the three-dimensional image, which uses the lenticular lens. As shown in FIG. 2, one surface of a lenticular lens 110 is in flat surface and semicylindrical convex portions (cylindrical lenses) 111 extending in one direction are formed in plural numbers on the other surface such that their longitudinal directions become parallel with each other. Then, as shown in FIG. 3, a display panel 114, where pixels 112a for the left eye displaying an image for the left eye 113a and pixels 112b for the right eye displaying an image for the right eye 113b are alternately arrayed, is arranged on the focal plane of the lenticular lens 110. Thus, light emitted from the pixels 112a for the left eye and the pixels 112b for the right eye is distributed by the lenticular lens 110 into directions for the left eyes 113a or the right eye 113b. Accordingly, the light from the different pixels reaches the viewer's right and left eyes, which allows the viewer to recognize the three-dimensional image.

A display for simultaneously displaying plural images has been developed as an image display device using a lenticular lens (see Japanese Patent Laid-Open Publication No. 332354/1994). This display simultaneously displays images different from one another in the direction of observation under the same conditions using the image distribution capability of a lenticular lens. That is, this display device can provide a plurality of viewers, positioned in different directions with respect to the display plane, with images different from one another. This can reduce the required set-up space and the power rate as compared with a case where image display devices equal in quantity to viewers are prepared.

In the conventional way, when optical unit such as the lenticular lens is mounted to the display panel such as the liquid crystal display panel, the method such as adhesion is used (see Japanese Patent Laid-Open Publication No. 101950/1999). FIG. 4 is a sectional view showing the method of mounting the conventional lenticular lens. As shown in FIG. 4, an adhesive layer 121 is provided over the flat surface of a conventional lenticular lens 120, and the lenticular lens 120 is fixed to the surface of the display panel such as the liquid crystal display panel by the adhesive layer 121.

However, the three-dimensional image display device described in Japanese Patent Laid-Open Publication No. 101950/1999 provided the adhesive layer over the surface of the optical unit, so that stress is generated in the fixed surface by difference in expansion coefficient between the optical unit and the display panel, when the three-dimensional image display device is used or stored in a place where temperature difference is large. As a result, there is generated a problem that the adhesive layer is isolated by the stress and the three-dimensional image display device is broken. This problem generally occurs not only in the three-dimensional image display device but also in the display which simultaneously displays images for plural viewpoints.

### SUMMARY OF THE INVENTION

It is an object of the invention to provide an image display device having the excellent durability and the manufacturing method thereof.

An image display device according to the present invention includes a display panel which has a plurality of pixel sections each of which includes at least a pixel displaying an image for the first viewpoint and a pixel displaying an image for the second viewpoint, the pixel sections being provided periodically in one direction; an optical unit refracts the light emitted from said pixels and emits the light in directions different from each other; and a fixing unit which is provide on at least a part of an area enclosing an image display area of the display panel, the fixing unit fixes the optical unit to the display panel.

In the image display device of the invention, since the optical unit is fixed in at least a part of the area which encloses the image display area of the display panel, when expansion and contraction of the optical unit and the display panel are caused by temperature change or the like, the optical unit and the display panel are bent so as to be separated from each other. As a result, compared with the case in which the optical unit is fixed over the surface of the display panel, the stress applied to the fixing unit can be relaxed and the durability of the image display device can be improved.

In the case where the optical unit is a lenticular lens having a plurality of semicylindrical lenses, longitudinal direction of which is perpendicular to the one direction, or a fly-eye lens having a plurality of convex lenses in which a lens pitch in the one direction and the lens pitch in a direction perpendicular to the one direction are different from each other, it is preferable that the fixing unit should be provided along a side extending in a longitudinal direction of the convex lens or longitudinal direction of the semicylindrical lens in the optical unit. The expansion coefficient of the lenticular lens is larger in the direction orthogonal to the longitudinal direction of the semicylindrical lens, compared with the longitudinal direction of the semicylindrical lens. Therefore, in the case where the optical unit is the lenticular lens or the fly-eye lens, the stress applied in the direction orthogonal to the longitudinal direction of the convex lens or the longitudinal direction of the semicylindrical lens can be relieved by forming the fixing unit along the side extending in the longitudinal direction of the convex lens or the longitudinal direction of the semicylindrical lens. Accordingly, even if the optical unit expands or contracts, the stress applied to the fixing unit is decreased, because a part where the fixing unit is not provided is deformed.

Further, in the case where the optical unit is the lenticular lens having a plurality of semicylindrical lenses, longitudinal direction of which is perpendicular to the one direction, or the fly-eye lens having a plurality of convex lenses in which a lens pitch in the one direction and the lens pitch in a direction perpendicular to the one direction are different from each other, it is also possible that the fixing unit is provided along the side extending in the direction orthogonal to the longitudinal direction of the convex lens or the longitudinal direction of said semicylindrical lens in the optical unit. This enables the optical unit to be fixed more securely to the display panel.

In the case the optical unit is the fly-eye lens having a plurality of convex lenses in which a lens pitch in the one direction and the lens pitch in a direction perpendicular to the one direction are equal to each other, it is preferable that the fixing unit should be provided along a short side of the optical unit. The expansion coefficient in the one direction and the expansion coefficient in a direction perpendicular to the one direction are equal to each other in the fly-eye lens having the convex lens in which the lens pitch in the one direction and the lens pitch in a direction perpendicular to the one direction are equal to each other. However, in the case where a length of the optical unit in the one direction is different from that in a direction perpendicular to the one direction, the amount of expansion of the optical unit in a short side direction becomes larger than that in a long side direction, because the amount of expansion is a product of the expansion coefficient and the side length. Therefore, when the optical unit expands or contracts, the stress can be relieved in the direction in which the fixing unit is not formed by forming the fixing unit along the short side of the optical unit, so that the stress applied to the fixing unit can be decreased.

In the case the optical unit is the fly-eye lens having a plurality of convex lenses in which the lens pitch in the one direction and the lens pitch in a direction perpendicular to the one direction are equal to each other, it is also possible that the fixing unit is provided along the side orthogonal to the short side of the optical unit. This enables the optical unit to be fixed more securely to the display panel.

The fixing unit may be provided so as to enclose the image display area in the display panel. At this point, it is preferable that a space that is formed by the optical unit, the display panel, and the fixing unit should be negative pressure than ambient atmosphere. The space which is formed by the optical unit, the display panel, and the fixing unit can be shielded from the ambient atmosphere by forming the fixing unit so as to enclose the image display area, and isolation of the optical unit from the display panel can be prevented by atmospheric pressure by setting the space to the negative pressure than the ambient atmosphere.

For example, the fixing unit is an adhesive. In this case, it is preferable that the adhesive should be a photo-setting adhesive which is cured by visible light. It is also possible that the adhesive contains fillers. In the case where the fixing unit is formed by the adhesive, as long as the adhesive is not cured, positions of the optical unit and the display panel can be adjusted even after the optical unit is arranged on the display panel, so that alignment can be performed with high accuracy. In particular, when the photo-setting adhesive which is cured by the visible light is used, production efficiency can be improved, because the curing can be performed for a short time without applying heat. When the fillers are added to the adhesive, since a thickness of the fixing unit can be controlled by the fillers, the adhesive which is of the fixing unit can be prevented from spreading onto the display area in fixing the optical unit to the display panel.

It is also possible that the fixing unit is a double-sided adhesive tape. Accordingly, spacing between the display panel and the optical unit is easily controlled, and the fixing unit can be prevented from spreading to the display area.

One or a plurality of aligning units that align the optical unit and the display panel when the optical unit is fixed to the display panel may be provided in at least one of the optical unit and the display panel. Therefore, the alignment between the display panel and the optical unit can be performed without displaying the image on the display panel.

For example, the aligning unit is provided at the position corresponding to each of four corners of the display panel. Therefore, shift in a rotational direction can be prevented to perform the alignment with higher accuracy.

The aligning unit may be provided in the area where the convex lenses of the optical unit are not formed. The aligning unit, which is provided in the display panel, can be easily recognized in the alignment by providing the aligning unit in a portion where the convex lens of the optical unit is not formed, and the optical unit and the display panel can be aligned with high accuracy.

The aligning unit may be provided on the surface of the optical unit on a side of the display panel. In the case where an image display surface in the display panel is a transparent substrate, it is preferable that the aligning unit should be provided on the surface of the transparent substrate. Since the positions of each aligning unit are brought close to each other by providing respectively the aligning unit on the surface of the transparent substrate and on the surface of the optical unit on the side of the display panel, the alignment between the optical unit and the display panel can be performed with high accuracy.

It is also possible that a slit-shaped opening or a pinhole-shaped opening is provided in the aligning unit which is formed in the display panel. Therefore, the alignment between the optical unit and the display panel can be performed in such a manner that the aligning unit is irradiated with the light to observe the light which has passed through the opening.

An optical film, which holds the spacing between the display panel and the optical unit, may be arranged between the image display area of the display panel and the optical unit. As a result, the optical film becomes a spacer, and the spacing between the display panel and the optical unit can be held constant.

In the case where the optical unit is formed of a plurality of convex lenses on one side and plane surface on the other side, the optical unit is arranged so that the convex lenses faces on the side of the viewer. As a result, the alignment can be performed with high accuracy, because the spacing between the optical unit and the display panel is decreased.

Further, in the case where the optical unit is formed of a plurality of convex lenses on one side and plane surface on the other side, the optical unit is arranged so that the convex lenses faces on the side of the display panel. By arranging the side on which the convex lenses is formed on the side of the display panel, a fringe caused by reflection of an exterior light on the surface of the optical unit can be decreased in the image that is recognized by the viewer, and the high-quality image can be displayed.

In the case where optical unit is arranged so that the convex lenses faces on the side of the display panel, it is preferable that gap-holding members which holds the spacing between the optical unit and the optical film should be arranged between the optical unit and the optical film. As a result, the spacing between the optical unit and the optical film can be held constant to prevent the optical unit from being pushed in the optical film.

Further, the longitudinal direction of the lenticular lens may be the longitudinal direction of the image display device in which case a three-dimensional image can be displayed adequately. Furthermore, the longitudinal direction of the lenticular lens may be the lateral direction of the image display device. In case where the image display device is mounted in a portable terminal device, this structure can allow a viewer to view the image display device from plural viewpoints different from one another by merely changing the angle of the portable terminal device and to view plural images. In case where the plural images have some correlation, particularly, the images can be viewed by the simple scheme of changing the observation angle. This improves the usability considerably. As the plural viewpoints are set in the longitudinal direction of images, the viewer can always view the images with both eyes. This improves the visibility of the individual images.

A method of manufacturing an image display device according to the invention includes a display panel which has a plurality of pixel sections each of which includes at least a pixel displaying an image for the first viewpoint and a pixel displaying an image for the second viewpoint, said pixel sections being provided periodically in one direction; and an optical unit refracts the light emitted from said pixels and emits the light in directions different from each other, comprises the steps of forming fixing unit including a liquid adhesive in an area which encloses an image display area of the display panel or in at least a part of the area corresponding to the area which encloses the image display area of the display panel in the optical unit, arranging the optical unit on the display panel, aligning the optical unit and the display panel by one or a plurality of aligning unit which is formed in at least one of the optical unit and the display panel, and fixing the optical unit to the display panel by curing the adhesive.

In the invention, since the adhesive is used as the fixing unit for fixing the optical unit to the display panel, the positions of the optical unit and the display panel can be finely adjusted after arranging the optical unit on the display panel, when the optical unit is fixed to the display panel. As a result, adhesion can be performed with higher accuracy, and productivity can be improved.

For example, the fixing unit is the photo-setting adhesive which is cured by irradiating the fixing unit with the visible light and the adhesive is cured by irradiating the fixing unit with the visible light. As a result, curing time can be shortened, and the curing can be efficiently performed because the visible light has higher transmittance in the optical unit.

Another method of manufacturing an image display device according to the invention includes a display panel which has a plurality of pixel sections each of which includes at least a pixel displaying an image for the first viewpoint and a pixel displaying an image for the second viewpoint, said pixel sections being provided periodically in one direction; and an optical unit has a plurality of convex lenses that refracts the light emitted from said pixels and emits the light in directions different from each other, comprises the steps of forming fixing unit including an adhesive material in an area which encloses an image display area of the display panel or in at least a part of the area corresponding to the area which encloses the image display area of the display panel in the optical unit, and arranging the optical unit on the display panel to fix the optical unit to the display panel by curing the adhesive material, while the optical unit and the display panel are aligned with each other by one or a plurality of aligning unit which are formed in at least one of the optical unit and the display panel.

In the invention, since the optical unit can be fixed to the display panel by pressing the optical unit to the display panel, the productivity can be improved.

In the case where the fixing unit is provided so as to enclose the image display area in the display panel, in the step of providing an opening in a part of the fixing unit to fix the optical unit to the display panel, it is also possible that the space which is formed by the optical unit, the display panel, and the fixing unit is shielded from the ambient atmosphere by sealing the opening after fixing the optical unit to the display panel. This allows the space which is formed by the optical unit, the display panel, and the fixing unit to be shielded from the ambient atmosphere. As a result, aging such as expansion caused by absorption of moisture contained in outside air can be suppressed.

At this point, it is also possible that the opening is sealed while the space that is formed by the optical unit, the display panel, and the fixing unit is set to negative pressure than the ambient pressure. As a result, the isolation of the optical unit can be prevented by the atmospheric pressure.

In the case where the plurality of aligning unit including the slit-shaped opening or the pinhole-shaped opening are provided in the display panel, it is also possible that the alignment is performed by irradiating each opening with the light having the wavelength different from one another. As a result, which positions of the aligning unit should be adjusted can be easily determined.

In the case where the plurality of aligning unit including the slit-shaped opening or the pinhole-shaped opening are provided in the display panel, it is also possible that the alignment is performed by irradiating the opening with the light to observe the position where the light which have passed through each opening are transmitted through the optical unit to cross each other. The general-purpose lens in which the aligning unit is not provided can be used as optical unit to perform the high-accuracy alignment by the simple method in such a manner that the opening is provided only in the display panel and the light transmitted through the optical unit is observed to perform the alignment. As a result, low cost can be realized and the productivity can be improved.

In the case where the optical unit is the lenticular lens, it is preferable that the alignment should be performed by using a line source of light extending in the longitudinal direction of the convex lens of the lenticular lens. As a result, even in the case where the lenticular lens in which the aligning unit is not formed is used as the optical unit, the alignment between the optical unit and the display panel can be easily performed.

Further, in the case where the optical unit is the lenticular lens having a plurality of semicylindrical lenses, longitudinal direction of which is perpendicular to the one direction, it is also possible that the alignment is performed only in the direction orthogonal to the longitudinal direction of the semicylindrical lens in the lenticular lens by the aligning unit. Since the high-accuracy alignment is required in only one direction, the production becomes easy and the productivity can be improved.

It is also possible that the step of fixing the optical unit to the display panel is performed under reduced pressure. As a result, the space that is enclosed by the optical unit, the display panel, and the fixing unit can be set to the negative pressure than the ambient atmosphere.

According to the invention, the fixing unit for fixing the optical unit to the display panel is provided in at least a part of the area enclosing the image display area of the display panel. Therefore, when the expansion or the contraction of the optical unit and the display panel is caused by temperature change or the like, the optical unit and the display panel are bent so as to be separated from each other, so that the stress applied to the fixing unit can be decreased, compared with the case in which the optical unit is fixed over the surface of the display panel. As a result, the image display device in which deterioration caused by the aging is decreased can be obtained.

### BRIEF DESCRIPTION OF THE DRAWINGS

FIG. 1 is a view of an optical model showing a method of displaying a three-dimensional image, which adopts a parallax barrier method;

FIG. 2 is a perspective view showing a lenticular lens;

FIG. 3 is a view of the optical model showing the method of displaying the three-dimensional image, which uses the lenticular lens;

FIG. 4 is a sectional view showing a method of mounting the conventional lenticular lens;

FIG. 5 is a perspective view showing a three-dimensional image display device according to a first embodiment of the invention;

FIG. 6 is an exploded sectional view showing schematically the three-dimensional image display device according to the first embodiment of the invention;

FIG. 7 is a top view showing schematically the three-dimensional image display device according to the first embodiment of the invention;

FIG. 8 is a top view showing a shape of a marker which is of aligning unit provided in the three-dimensional image display device according to the first embodiment of the invention;

FIG. 9 is a perspective view showing a cellular phone in which the three-dimensional image display device according to the first embodiment of the invention is incorporated;

FIG. 10 is a perspective view showing a fly-eye lens;

FIG. 11A and FIG. 11B are top views showing a method of manufacturing the three-dimensional image display device according to a second embodiment of the invention in order of its process;

FIG. 12 is a top view showing the three-dimensional image display device according to a third embodiment of the invention;

FIG. 13 is a perspective view showing a method of manufacturing a metal mold which is used in manufacturing the lenticular lens;

FIG. 14A and FIG. 14B are top views showing the method of manufacturing the three-dimensional image display device according to a fourth embodiment of the invention in order of its process;

FIG. 15 is a top view showing the three-dimensional image display device according to a fifth embodiment of the invention;

FIGS. 16A and 16B are conceptual views showing a method of aligning the three-dimensional image display device according to a sixth embodiment of the invention;

FIG. 17 is a top view showing the three-dimensional image display device according to a seventh embodiment of the invention;

FIG. 18 is a top view showing a light source which is used for the three-dimensional image display device according to the seventh embodiment of the invention;

FIGS. 19A to 19C are schematic diagrams showing the method of manufacturing the three-dimensional image display device according to an eighth embodiment of the invention;

FIG. 20 is a top view showing the three-dimensional image display device according to a ninth embodiment of the invention;

FIG. 21 is a top view showing the three-dimensional image display device according to a tenth embodiment of the invention;

FIG. 22 is a top view showing the three-dimensional image display device according to an eleventh embodiment of the invention;

FIG. 23 is a top view showing a first modification of the three-dimensional image display device according to the eleventh embodiment of the invention;

FIG. 24 is a sectional view showing a second modification of the three-dimensional image display device according to the eleventh embodiment of the invention;

FIG. 25 is a sectional view showing a third modification of the three-dimensional image display device according to the eleventh embodiment of the invention;

FIGS. 26A to 26C are top views showing the method of manufacturing the three-dimensional image display device according to a twelfth embodiment of the invention in order of its process;

FIG. 27 is a top view showing the three-dimensional image display device according to a thirteenth embodiment of the invention;

FIGS. 28A to 28D are top views showing the method of manufacturing the three-dimensional image display device according to a fourteenth embodiment of the invention in order of its process;

FIG. 29 is a top view showing the three-dimensional image display device according to a fifteenth embodiment of the invention;

FIGS. 30A to 30D are top views showing the method of manufacturing the three-dimensional image display device according to a sixteenth embodiment of the invention in order of its process;

FIG. 31 is a top view showing the three-dimensional image display device according to a seventeenth embodiment of the invention;

FIGS. 32A to 32D are top views showing the method of manufacturing the three-dimensional image display device according to an eighteenth embodiment of the invention in order of its process;

FIG. 33 is a perspective view of a portable terminal device in which the image display device of a nineteenth embodiment of the invention is mounted;

FIG. 34 is a diagram of the optical model illustrating the operation of an image display device in the nineteenth embodiment of the invention.

FIG. 35 is a top view showing the three-dimensional image display device according to an exemplary embodiment of the present invention;

FIG. 36 is a top views showing the three-dimensional image display device according to another exemplary embodiment of the present invention;

FIG. 37 is a top view showing the three-dimensional image display device according to another exemplary embodiment of the present invention;

FIG. 38 is a top view showing the three-dimensional image display device according to another exemplary embodiment of the present invention; and

FIG. 39 is a top view showing the three-dimensional image display device according to still another exemplary embodiment of the present invention.

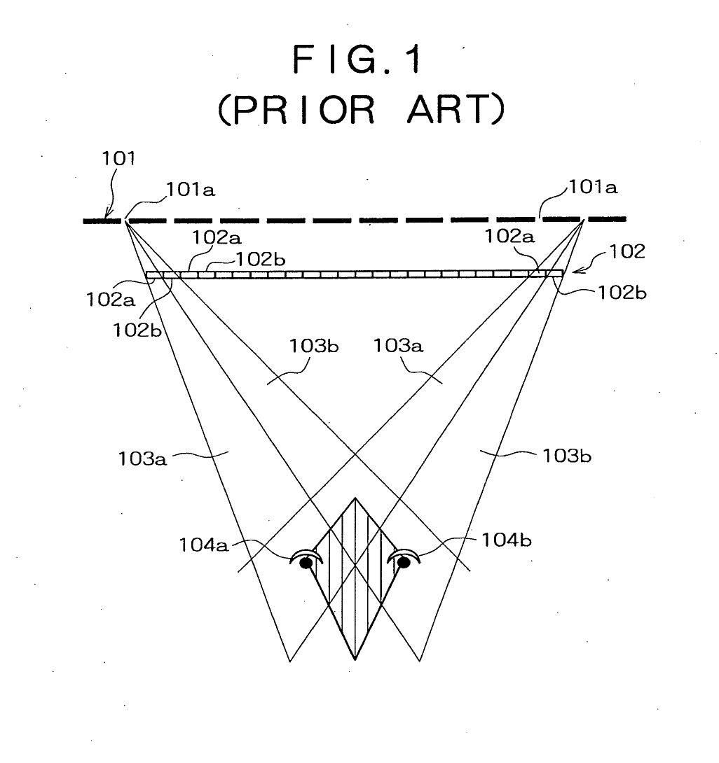

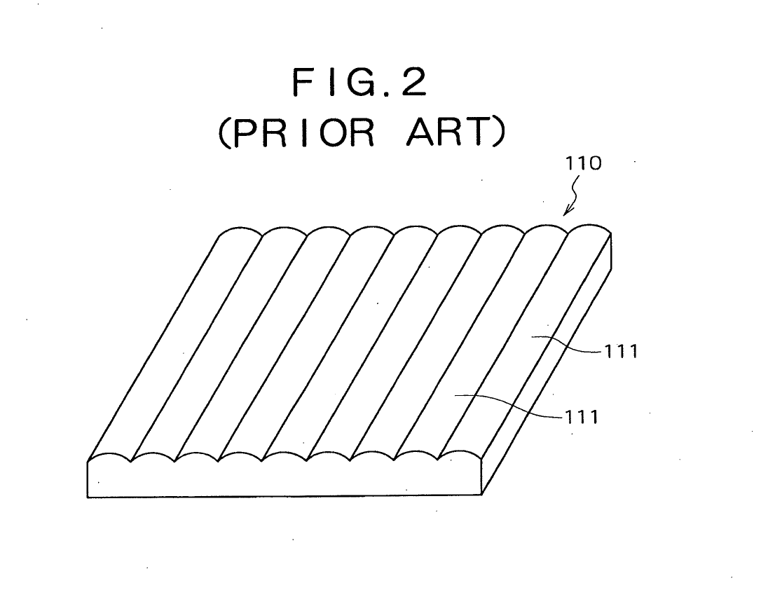

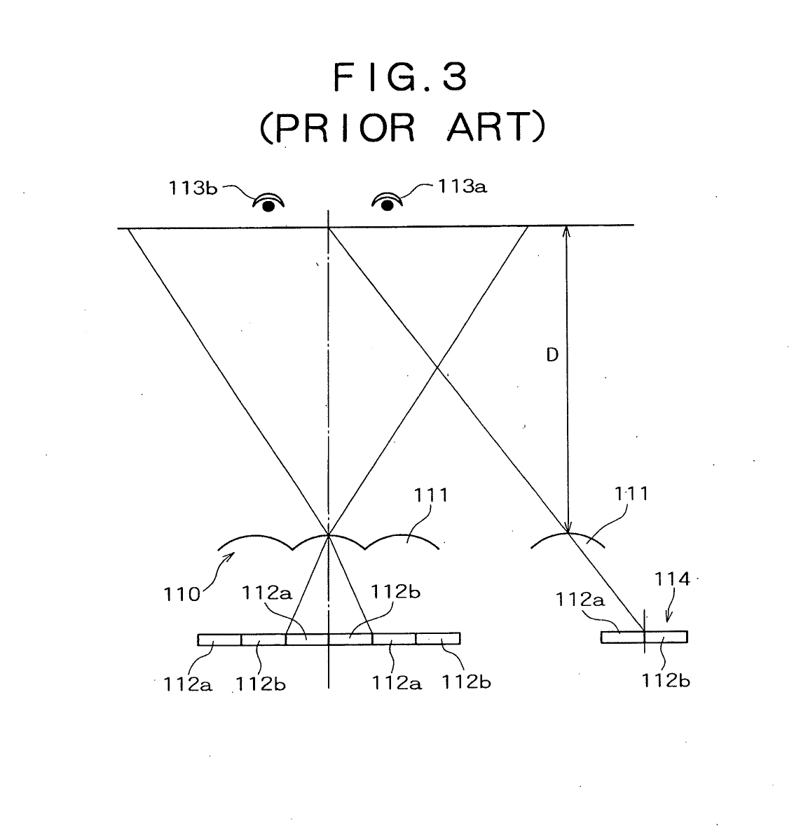

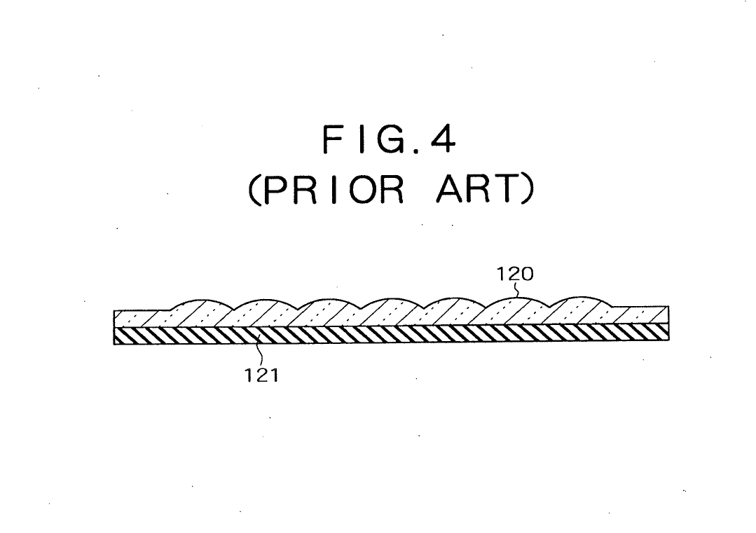

### DETAILED DESCRIPTION OF THE PREFERRED EMBODIMENTS

In the conventional three-dimensional image display device, the problem that the adhesive layer fixing the optical unit to the display panel is peeled off is caused by the stress, which is generated by the difference in expansion coefficient between the optical unit and the member to which the optical unit is fixed. In the three-dimensional image display device of the invention, the fixing unit that fixes the optical unit to the display panel is provided not over the surface of the display panel but on at least a part of the area, which encloses the image display area of the display panel. Therefore, when the expansion or the contraction of the optical unit and the display panel is caused by the temperature change or the like, the optical unit and the display panel are bent so as to be separated from each other, so that the stress applied to the fixing unit can be relaxed.

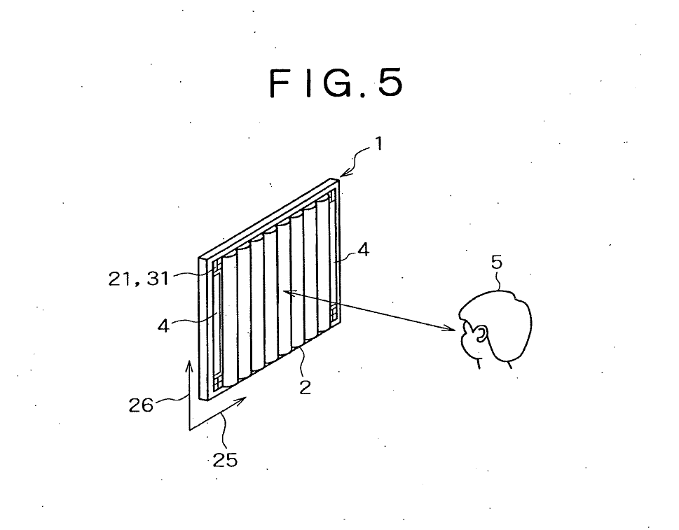

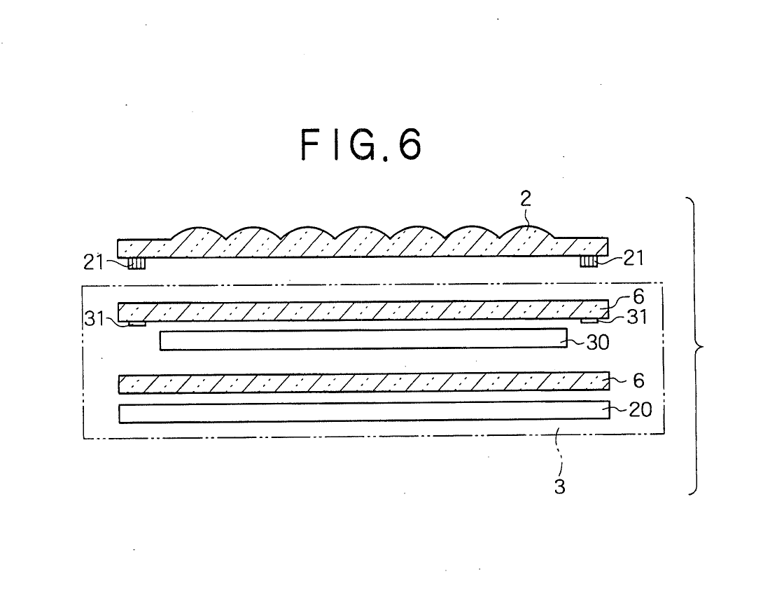

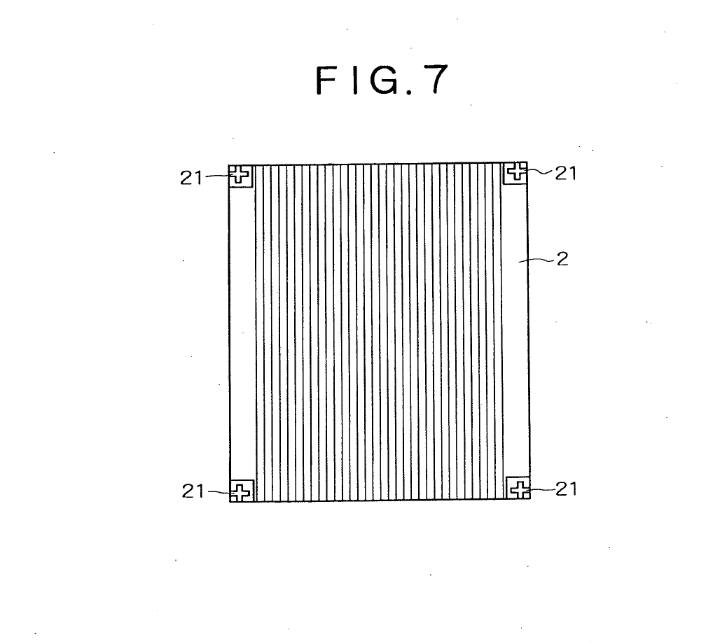

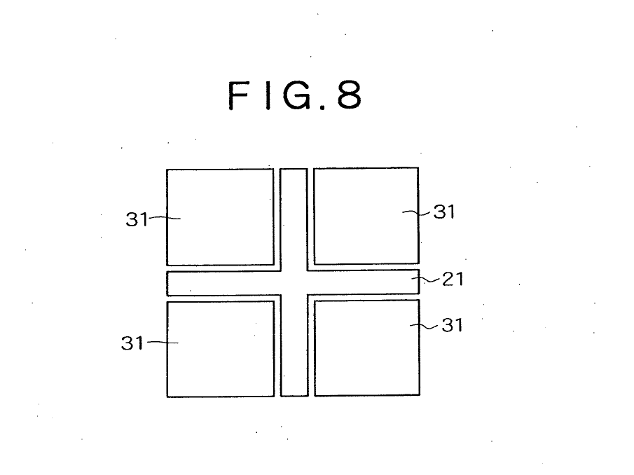

The three-dimensional image display device according to preferred embodiments of the invention will be specifically described below referring to the accompanying drawings. At first, the three-dimensional image display device according to a first embodiment of the invention will be described. FIG. 5 is the perspective view showing the three-dimensional image display device according to the embodiment, FIG. 6 is the exploded sectional view showing schematically the three-dimensional image display device, and FIG. 7 is the top view of the three-dimensional image display device. FIG. 8 is the top view showing a shape of a marker which is of the aligning unit provided in the three-dimensional image display device of the embodiment. As shown in FIG. 5 and FIG. 6, a transmissive liquid crystal display panel 3 as the display panel and a lenticular lens 2 as the optical unit are provided in a three-dimensional image display device 1 of the embodiment, and the lenticular lens 2 is fixed to the surface of the liquid crystal display panel 3 on the side of a viewer 5. A marker 21 for lens which aligns the lenticular lens 2 with the liquid crystal display panel 3 is provided in the lenticular lens 2, and a marker 31 for display panel is provided in the liquid crystal display panel 3. Further, in the three-dimensional image display device 1 of the embodiment, fixing unit 4 is provided along the side extending in the longitudinal direction of the lenticular lens 2.

The lenticular lens 2, in which one of the surfaces is flat and a plurality of semicylindrical convex portions (cylindrical lenses) are formed so as to be parallel to one another in the other surface, is used as the optical unit in the three-dimensional image display device 1 of the embodiment. The lenticular lens 2 is arranged so that a vertical direction 26 is parallel to the longitudinal direction and the flat surface is formed on the side of liquid crystal display panel 3.

The liquid crystal display panel 3 is used as the display panel of the three-dimensional image display device 1 of the embodiment. In the liquid crystal display panel 3, the pixels displaying the image for the right eye and the pixels displaying the image for the left eye are alternately arrayed along a horizontal direction 25 between a pair of transparent substrates 6 made of glass or the like, and the pixels displaying the image for the right eye and the pixels displaying the image for the left eye are arrayed along the vertical direction 26. Each of pixels for the right eye and pixels for the left eye has a sub-pixel for red, a sub-pixel for green and a sub-pixel for blue. One cylindrical lens corresponds to the column, in which the pair of pixels adjacent to each other is arrayed along the vertical direction 26. A light source 20 is arranged on the backside of the pixel. A display surface of the liquid crystal display panel 3 is formed by the transparent substrate 6, the display surface is a plane which includes the horizontal direction 25 and the vertical direction 26, and the horizontal direction 25 and the vertical direction 26 are orthogonal to each other.

The fixing unit 4 is provided along the side extending in the longitudinal direction of the cylindrical lens in the lenticular lens 2 between the markers in the three-dimensional image display device 1 of the embodiment. For example, a double-sided adhesive tape 40 can be used as the fixing unit 4. Generally, plastic resins such as acrylic resins or polycarbonate resins are used as a material of the lenticular lens 2. However, in the case where the display surface of the liquid crystal display panel 3 is formed by the glass substrate, the thermal expansion coefficients of these resins are about ten times as large as that of glass. As a result, when the lenticular lens 2 is fixed to the whole display surface of the liquid crystal display panel 3, the fixing unit 4 can not withstand the expansion and the contraction which are caused by the temperature change, so that the cylindrical lens 2 is peeled off from the display surface. Therefore, in the three-dimensional image display device 1 of the embodiment, the fixing unit 4 is provided along an end portion of the horizontal direction 25 where the expansion coefficient and the contraction coefficient are higher in the lenticular lens 2, i.e. along the side extending in the longitudinal direction of the lenticular lens 2.

As shown in FIG. 6, in the three-dimensional image display device 1 of the embodiment, the marker 21 for lens is provided on the surface of the lenticular lens 2 on the side of the liquid crystal display panel 3. Generally, since wiring or the like is formed on the surface of the transparent substrate on the side of the pixel in the liquid crystal display panel 3, the marker 31 for display panel can be also formed in a process of forming the wiring on the transparent substrate 6 by forming the marker 31 for display panel on the surface on which the wiring of the transparent substrate 6 is formed (the surface on the side of the pixel). However, when the spacing between the marker 21 for lens and the marker 31 for display panel is increased, accuracy of alignment is decreased. Therefore, in the three-dimensional image display device 1 of the embodiment, in order to shorten the distance between the marker 21 for lens and the marker 31 for display panel, the marker 21 for lens is formed on the surface of the lenticular lens 2 on the side of the liquid crystal display panel 3, and the marker 31 for display panel is formed on the surface of the transparent substrate 6 which is arranged on the side of the lenticular lens 2.

As shown in FIG. 6 and FIG. 7, the marker 21 for lens is provided in a portion where the cylindrical lens is not formed. Each of the markers 21 for lens and each of the markers 31 for display panel are arranged at four corners of the liquid crystal display panel 3. As shown in FIG. 8, in the three-dimensional image display device 1 of the embodiment, the marker 21 for lens is formed in the shape of a cross and the marker 31 for display panel is formed in the shape in which the shape corresponding to the marker 21 for lens is removed from a square.

Operation of the three-dimensional image display device 1 of the embodiment, which is configured in the above-described way, will be described below. In the three-dimensional image display device 1 of the embodiment, the traveling directions of the light outgoing from the pixels 30 are changed by the lenticular lens 2, and the light outgoing from the pixel for the right eye is incident to the right eye of the viewer 5 while the light outgoing from the pixel for the left eye is incident to the left eye of the viewer 5. As a result, the light outgoing from the different pixels reach the right and left eyes of the viewer 5 respectively, which allows the viewer 5 to recognize the image displayed on the liquid crystal display panel 3 as the three-dimensional image.

In the three-dimensional image display device 1 of the embodiment, when the lenticular lens 2 expands or contracts, the portion of the lenticular lens 2 which is not fixed to the liquid crystal display panel 3 is deformed by providing the fixing unit 4 along the side extending in the longitudinal direction (vertical direction 26) of the lenticular lens 2, so that the stress applied to the fixing unit 4 can be decreased and the fixing unit 4 can be prevented from deterioration caused by aging. In the three-dimensional image display device 1 of the embodiment, the distance between the marker 21 for lens and the marker 31 for display panel is shortened in such a manner that the marker 21 for lens is formed on the surface of the lenticular lens 2 on the side of the liquid crystal display panel 3 and the marker 31 for display panel is formed on the transparent substrate 6 which is arranged on the side of the lenticular lens 2, so that the alignment between the lenticular lens 2 and the liquid crystal display panel 3 can be performed with higher accuracy. In the three-dimensional image display device 1 of the embodiment, the marker 21 for lens is provided in the portion where the cylindrical lens is not formed. Accordingly, when the alignment is performed, a position of the marker 31 for display panel is easily recognized, and the high-accuracy alignment can be realized. Further, the alignment can be performed with high accuracy in both the vertical direction and the horizontal direction by forming the marker 21 for lens and the marker 31 for display panel in the shapes shown in FIG. 8.

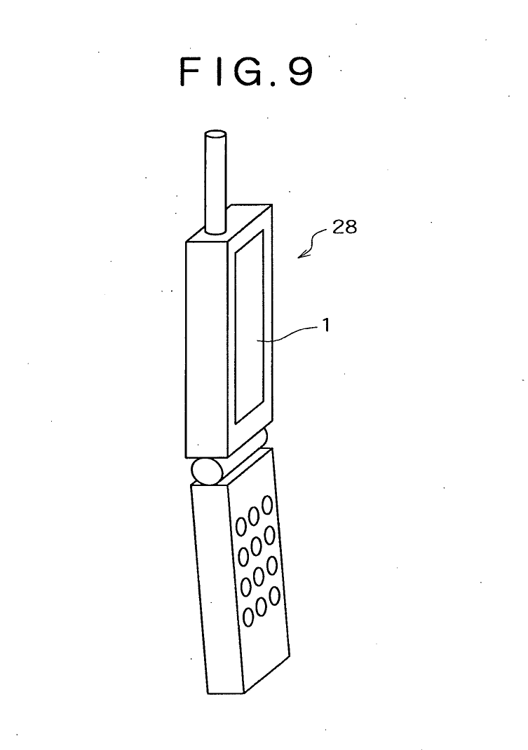

The three-dimensional image display device 1 of the embodiment can be used for various portable terminals such as the cellular phone, PDA, a game machine, a digital camera, and a digital video camera. FIG. 9 is the perspective view showing the cellular phone in which the three-dimensional image display device of the embodiment is incorporated. Like a cellular phone 28 shown in FIG. 9, the high-quality three-dimensional image display in which deterioration caused by the temperature change is decreased can be realized by incorporating the three-dimensional image display device 1 of the embodiment as the display device in the cellular phone 28.

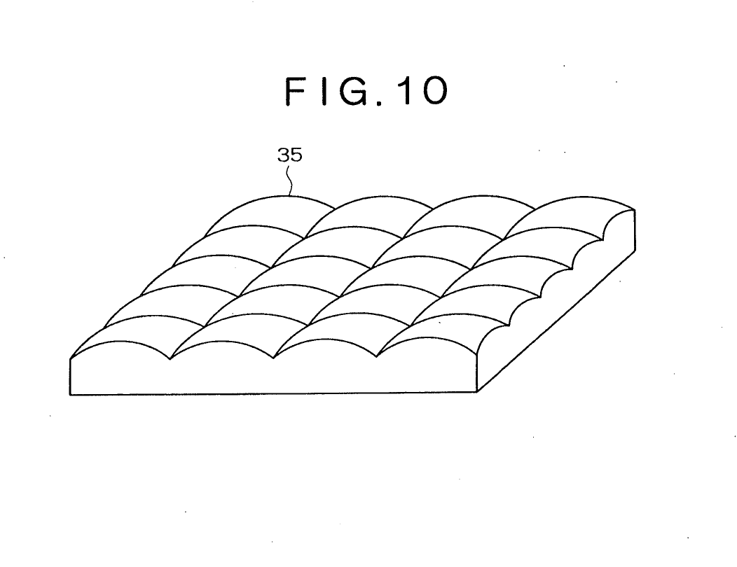

Although the three-dimensional image display device in which the lenticular lens 2 is used was described in the embodiment, the invention is not limited to the three-dimensional image display device in which the lenticular lens 2 is used. For example, the fly-eye lens in which the usual convex lenses are arrayed in a matrix can be also used. FIG. 10 is the perspective view showing the fly-eye lens where the convex lenses have the same lens pitch in both the longitudinal and the lateral direction. However, it is also possible to have a fly-eye lens where the convex lenses have different pitches in the horizontal and lateral directions. For example, the fly-eye lens may have a lens pitch in the longitudinal direction which is larger than the lens pitch in a lateral direction. The four different images can be displayed in four directions of horizontal directions and vertical directions by using a fly-eye lens 35 shown in FIG. 10 as the optical unit.

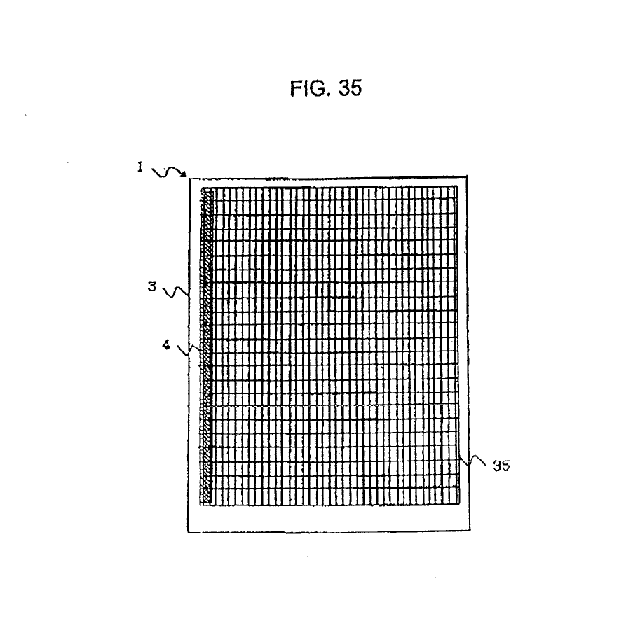

FIG. 35 shows a three-dimensional image display device using this configuration. The three-dimensional display device 1 includes a liquid crystal display panel 3. The fixing unit 4 is provided on a side in a lateral direction of a fly-eye lens 35 and extends along a side edge in a longitudinal direction of the fly-eye lens 35. The fly-eye lens 35 is longitudinally long (in which a lens pitch in the longitudinal direction is larger than the lens pitch in a lateral direction).

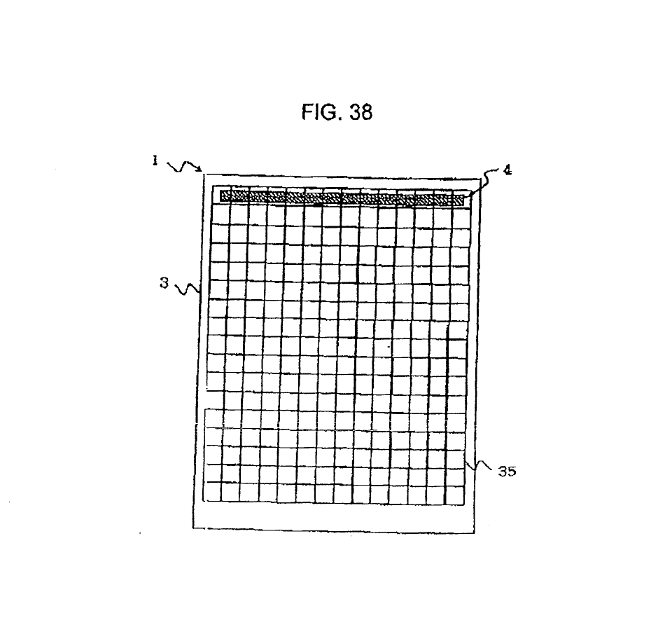

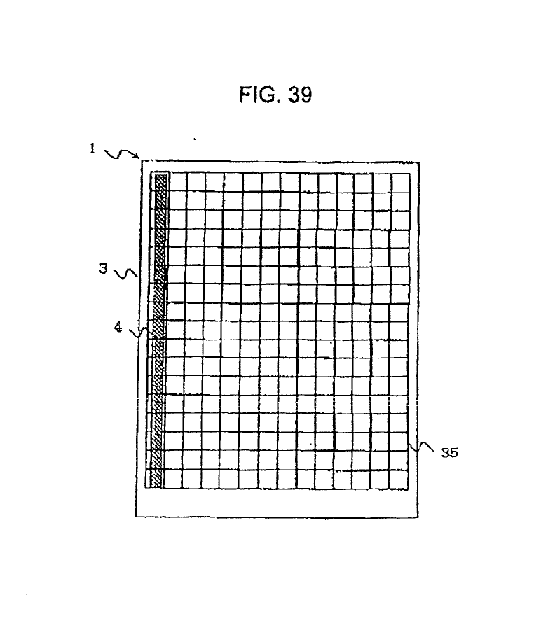

FIGS. 38 and 39 each show a three-dimensional image display device 1 having a liquid crystal display panel 3. In both FIGS. 38 and 39, the fly-eye lens 35 has convex lenses in which the lens pitch in the longitudinal direction and the lens pitch in the lateral direction are equal to each other (i.e. grid-like squares in the figure). FIG. 38 shows the fixing unit 4 provided along the short side of the fly-eye lens 35 in which the lens pitch in the longitudinal and lateral directions are equal. FIG. 39 shows the fixing unit 4 provided along a side orthogonal to the short side of the fly-eye lens 35 in which the lens pitch in the longitudinal and lateral directions are equal.

Although the three-dimensional image display device in which the transmissive liquid crystal display panel is used as the display panel was described in the embodiment, the invention is not limited to this. A reflective liquid crystal display panel, a slight-transmissive liquid crystal display panel, or a semi-transmissive liquid crystal display panel in which a transmissive region and a reflective region are provided in each pixel can be also used as the display panel. An active matrix method such as a TFT (Thin Film Transistor) method and a TFD (Thin Film Diode) method can be adopted as the method of driving the liquid crystal display panel, and a passive matrix method such as an STN (Super Twisted Nematic liquid crystal) method can be also adopted. The display panel except the liquid crystal display panel, such as an organic electro luminescence display panel, a plasma display panel, a CRT (Cathode-Ray Tube) display panel, an LED (Light Emitting Diode) display panel, a field emission display panel, or a PALC (Plasma Address Liquid Crystal) display panel, can be also used as the display panel.

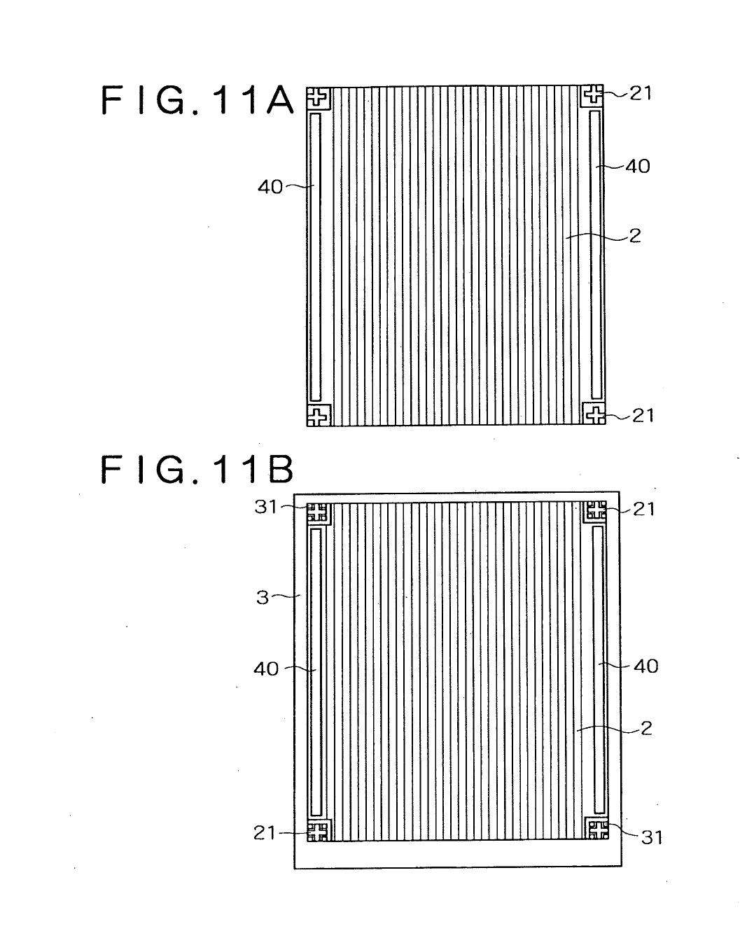

Then, the method of manufacturing the three-dimensional image display device 1 of the first embodiment will be described as a second embodiment of the invention. FIG. 11A and FIG. 11B are the tops view showing the method of manufacturing the three-dimensional image display device of the second embodiment in order of its process. As shown in FIG. 11A, at first a double-sided adhesive tape 40 is caused to adhere to the flat surface of the lenticular lens 2, in which the marker 21 for lens is formed, along the side extending in the longitudinal direction of the cylindrical lens. Then, as shown in FIG. 11B, the lenticular lens 2 is caused to adhere to the liquid crystal display panel 3 having the marker 31 for display panel while the marker 21 for lens and the marker 31 for display panel are aligned with each other.

In the case where the tape material such as the double-sided adhesive tape 40 is used as the fixing unit 4, it is impossible to finely adjust the positions of the lenticular lens 2 and the liquid crystal display panel 3 after the adhesion. Therefore, in the method of manufacturing the three-dimensional image display device 1 of the embodiment, the alignment between the lenticular lens 2 and the liquid crystal display panel 3 is performed, while the positions of the marker 21 for lens and the marker 31 for display panel are being confirmed by changing gradually the distance between the lenticular lens 2 and the liquid crystal display panel 3. This allows the high-accuracy alignment. Unlike the conventional method of manufacturing the three-dimensional image display device, the alignment between the lenticular lens 2 and the liquid crystal display panel 3 can be performed without displaying the image on the liquid crystal display panel 3, so that the productivity can be improved.

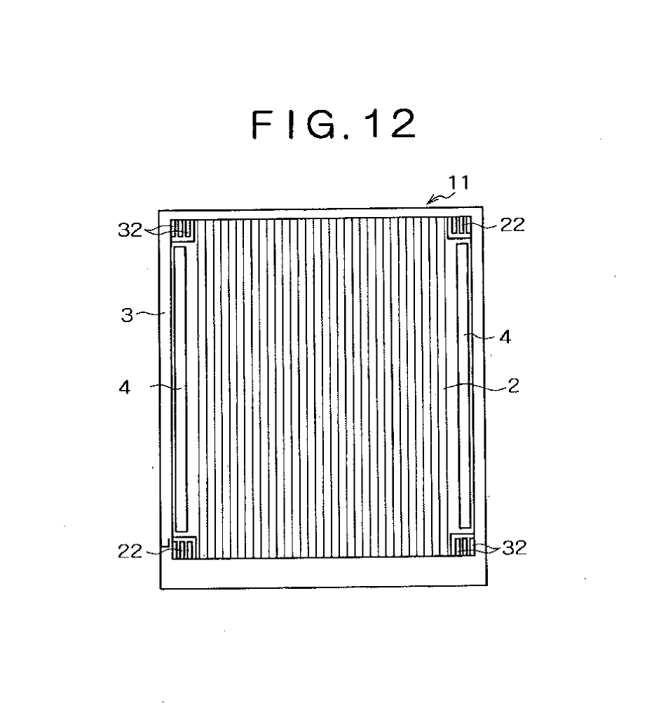

Then, the three-dimensional image display device according to a third embodiment of the invention will be described. FIG. 12 is the top view showing the three-dimensional image display device according to the third embodiment of the invention. Similarly to the three-dimensional image display device 1 of the first embodiment shown in FIG. 5, the transmissive liquid crystal display panel 3 as the display panel and the lenticular lens 2 as the optical unit are provided in a three-dimensional image display device 11 of the embodiment. The lenticular lens 2 is fixed so that the surface in which the cylindrical lens is formed faces the side of the liquid crystal display panel 3. Each of markers 22 for lens and each of markers 32 for display panel, which are the aligning unit for aligning the lenticular lens 2 with the liquid crystal display panel 3 respectively, are provided at the four corners of the lenticular lens 2 and the liquid crystal display panel 3. A rectangular solid-shaped convex portion is formed in the marker 22 for lens. For example, a height is 10 μm, and a width is 20 μm, and a length is 1 mm in a size of the rectangular convex portion. The longitudinal direction of the rectangular solid-shaped convex portion is parallel to the longitudinal direction of the cylindrical lens in the lenticular lens 2. In the marker 32 for display panel, two slit-shaped openings having the same interval as the width of the convex portion of the marker 22 for lens are formed in the longitudinal direction of the cylindrical lens in the lenticular lens 2. In the three-dimensional image display device 11 of the embodiment, the fixing unit 4 is provided along the side extending in the longitudinal direction of the lenticular lens 2.

The operation of the three-dimensional image display device 11 of the embodiment, which is configured in the above-described way, will be described below. In the three-dimensional image display device 11 of the embodiment, similarly to the three-dimensional image display device 1 of the first embodiment, the traveling directions of the light outgoing from the pixels of the liquid crystal display panel 3 are changed by the lenticular lens 2, and the light outgoing from the different pixels reach the right and left eyes of the viewer respectively. This allows the viewer to recognize the image displayed on the liquid crystal display panel 3 as the three-dimensional image.

In the three-dimensional image display device adopting the lenticular lens method, the high-accuracy alignment is required for the direction orthogonal to the longitudinal direction of the cylindrical lens in the lenticular lens 2. However, the diffraction directions of the light are the same for the longitudinal direction of the cylindrical lens, and the cylindrical lens has no lens effect, so that a quantity of error can be permitted in the accuracy of position. For example, the alignment of the cylindrical lens in the longitudinal direction can be performed by a technique in which an end face of the liquid crystal display panel 3 is aligned with the end face of the lenticular lens 2. Accordingly, in the three-dimensional image display device 11 of the embodiment, the alignment between the lenticular lens 2 and the liquid crystal display panel 3 is performed such that the convex portion whose longitudinal direction is parallel to the longitudinal direction of the cylindrical lens in the lenticular lens 2 is formed in the marker 22 for lens and the convex portion is located between the two slit-shaped openings formed in the marker 32 for display panel. Only by performing the alignment in the direction orthogonal to the longitudinal direction of the cylindrical lens, the alignment process becomes simple and the productivity can be improved.

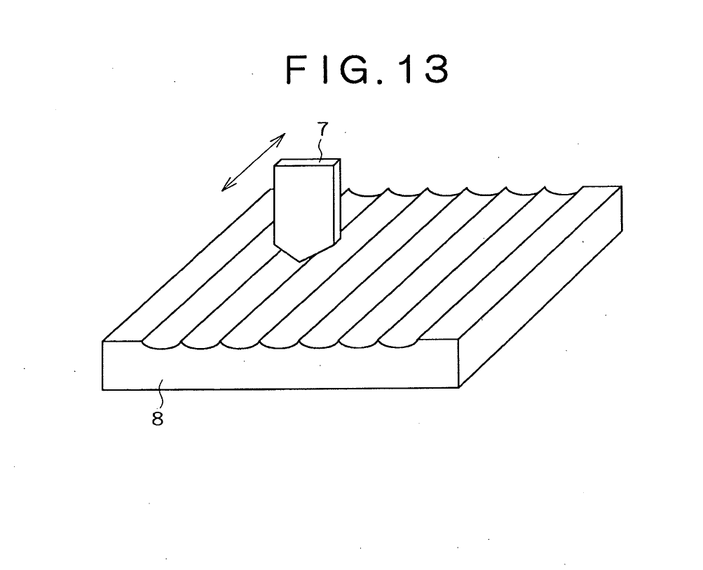

Usually the lenticular lens 2 is produced in such a manner that the metal mold which becomes a matrix mold is produced and press working is performed to a plate-shaped plastic substrate with the metal mold. FIG. 13 is the perspective view showing the method of manufacturing the metal mold which is used in manufacturing the lenticular lens. As shown in FIG. 13, a metal mold 8 for manufacturing the lenticular lens is produced by ultra precision cutting, and a cutting tool 7 is moved in the direction parallel to the longitudinal direction of the cylindrical lens in the lenticular lens during the ultra precision cutting. Therefore, in the lenticular lens, it is easy to form the convex portion parallel to the longitudinal direction of cylindrical lens, and the marker 22 for lens can be also formed in molding the lenticular lens. As shown in FIG. 12, the marker 22 for lens is easy to form on the surface of the lenticular lens 2 by forming the marker for lens 22 in the shape extending in the longitudinal direction of the cylindrical lens. This shape is particularly advantageous in the case where the marker and the lenticular lens are formed in the same process.

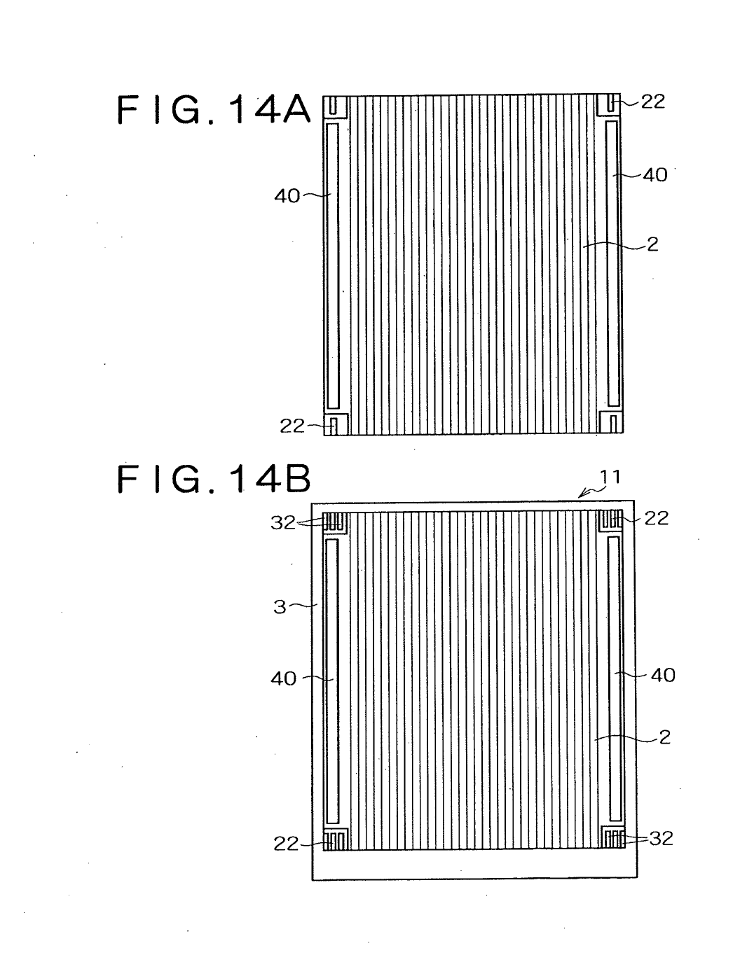

Then, the method of manufacturing the three-dimensional image display device 11 of the third embodiment will be described as a fourth embodiment of the invention. FIG. 14A and FIG. 14B are the top views showing the method of manufacturing the three-dimensional image display device of the embodiment in order of its process. As shown in FIG. 14A, at first the double-sided adhesive tape 40 which is of the fixing unit is caused to adhere to the surface of the lenticular lens 2, on which the cylindrical lens is formed, along the side extending in the longitudinal direction of the cylindrical lens. Each of the markers 22 for lens is formed at the four corners in the lenticular lens 2. Then, as shown in FIG. 14B, the lenticular lens 2 and the liquid crystal display panel 3 are aligned with each other so that the convex portion of the markers 22 for lens is located between the two slit-shaped openings which are formed in the marker 32 for display panel provided at the four corners of the liquid crystal display panel 3. That is to say, the alignment is performed to the direction orthogonal to the longitudinal direction of the cylindrical lens in the lenticular lens 2 by aligning the convex portion of the marker 22 for lens with the slit-shaped opening of the marker 32 for display panel. Then, the lenticular lens 2 and the liquid crystal display panel 3 are caused to adhere to each other with the double-sided adhesive tape 40. For the longitudinal direction of the cylindrical lens, the alignment is performed by the end face of the lenticular lens 2 and the end face of the liquid crystal display panel 3.

In the method of manufacturing the three-dimensional image display device 11 of the embodiment, since it is necessary to perform the high-accuracy alignment in only one direction (the direction orthogonal to the longitudinal direction of the cylindrical lens), the alignment becomes easy, as a result, the productivity can be improved.

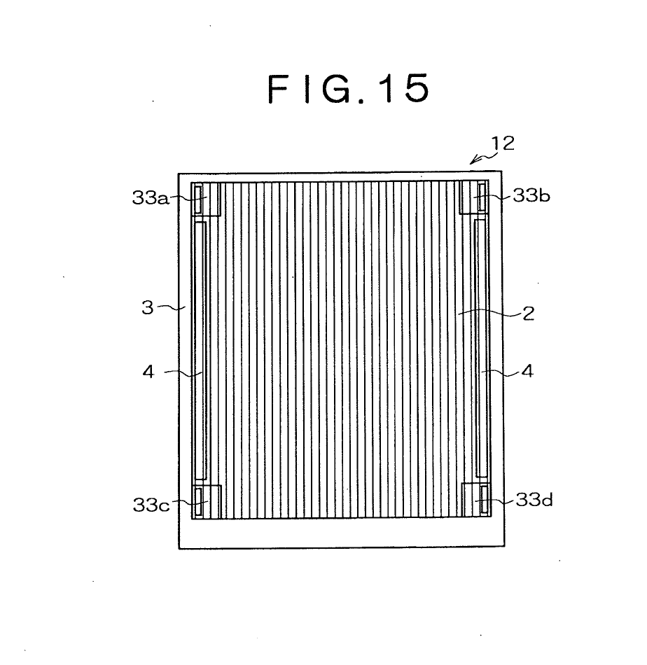

The three-dimensional image display device according to a fifth embodiment of the invention will be described below. FIG. 15 is the top view showing the three-dimensional image display device according to the fifth embodiment of the invention. As shown in FIG. 15, the liquid crystal display panel 3 and the lenticular lens 2 are provided in a three-dimensional image display device 12 of the embodiment. The lenticular lens 2 is fixed so that the surface in which the cylindrical lens is formed becomes the side of the liquid crystal display panel 3. Unlike the three-dimensional image display device of the first and third embodiments, in the three-dimensional image display device 12 of the embodiment, the cylindrical lens is formed even in the corners of the lenticular lens 2 and the marker for lens is not formed in the corners. Markers 33a to 33d for display panel are formed in the four corners of the liquid crystal display panel 3. In each of the markers 33a to 33d for display panel, the slit-shaped opening is formed in the longitudinal direction of the cylindrical lens.

The operation of the three-dimensional image display device 12 of the embodiment, which is configured in the above-described way, will be described below. In the three-dimensional image display device 12 of the embodiment, similarly to the three-dimensional image display device of the first and third embodiments, the traveling directions of the light outgoing from the pixels of the liquid crystal display panel 3 are changed by the lenticular lens 2, and the light outgoing from the different pixels reach the right and left eyes of the viewer respectively. This allows the viewer to recognize the image displayed on the liquid crystal display panel 3 as the three-dimensional image.

In the three-dimensional image display device, since the optical unit and the display panel are usually arranged so that the distance between the lens and the pixel becomes a focal distance, the distance between the lenticular lens 2 and the markers for 33a to 33d display panel is substantially equal to the focal distance. Therefore, in the three-dimensional image display device 12 of the embodiment, the light for alignment passes through the opening of the markers 33a to 33d for display panel to become a line source of light, and the light for alignment substantially becomes a parallel light to be outputted from the lenticular lens 2. In the case where the relative positional relationship between the opening of the markers 33a to 33d for display panel and the center of the lenticular lens 2 is changed, since the position irradiated with the light for alignment is also changed on an observation plane, the alignment between the lenticular lens 2 and the liquid crystal display panel 3 can be performed so that the position irradiated with the light for alignment becomes the desired position. In the three-dimensional image display device 12 of the embodiment, the alignment between the lenticular lens 2 and the liquid crystal display panel 3 can be performed only by the markers 33a to 33d for display panel. Accordingly, even if the general-purpose lenticular lens in which the marker for alignment is not formed is used, the high-accuracy alignment can be performed by the simple method. As a result, the production cost can be decreased to improve the productivity.

In the three-dimensional image display device 12 of the embodiment, although the markers for display panel were formed in the four corners of the liquid crystal display panel 3, the invention is not limited to this. The plurality of markers for display panel can be formed in the display panel. The provision of the plurality of markers in the display panel can detect position shift in each marker by using the light for alignment having different wavelength for each marker. Accordingly, the accuracy of the alignment is improved.

Although the case in which the slit-shaped opening is formed in the markers 33a to 33d for display panel was described in the embodiment, the alignment can be also similarly performed by not the slit-shaped opening but a pinhole-shaped opening of the markers 33a to 33d for display panel. While the shape of the area irradiated with the light for alignment becomes a dot shape on the observation plane in the case of the pinhole-shaped opening of the markers 33a to 33d for display panel, the shape of the area irradiated with the light for alignment becomes a line shape on the observation plane in the case of the slit-shaped opening of the markers 33a to 33d for display panel. Therefore, in the markers 33a to 33d for display panel, larger illuminance can be obtained on the observation plane by the slit-shaped opening, compared with the pinhole-shaped opening. However, in the case where the fly-eye lens is used as the optical unit instead of the lenticular lens 2, since the alignment can be performed in both the vertical direction and the horizontal direction, the shape of the opening of the markers 33a to 33d for display panel is the pinhole shape.

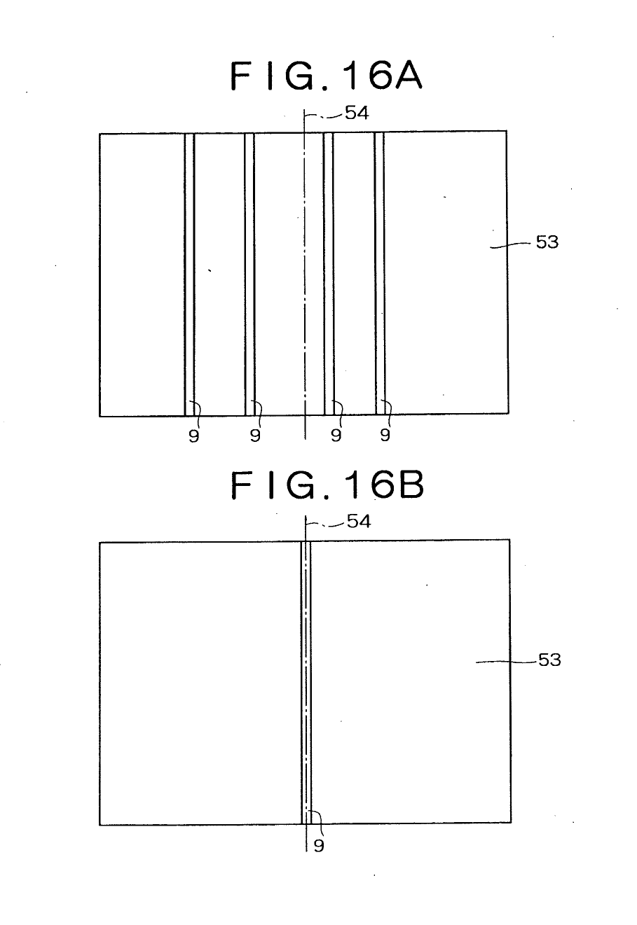

Then, the method of manufacturing the three-dimensional image display device 12 of the fifth embodiment will be described as a sixth embodiment of the invention. FIGS. 16A and 16B are conceptual views showing the method of aligning the three-dimensional image display device of the embodiment. In the method of manufacturing the three-dimensional image display device 12 of the embodiment, light 9 are emitted from a light source for alignment (not shown) arranged on the backside of the marker for display panel and pass through the openings provided in the marker for display panel, and the positions of the lenticular lens and the liquid crystal display panel are aligned so that the light 9 correspond to one another in the center 54 of an observation plane 53 corresponding to a central portion of the liquid crystal display panel.

Specifically, similarly to the fourth embodiment, at first the double-sided adhesive tape is caused to adhere to the surface of the lenticular lens on the side of the cylindrical lens. Then, the lenticular lens is brought close to the liquid crystal display panel while the surface on the side of the cylindrical lens faces the side of the liquid crystal display panel, the light is emitted from the light source for alignment arranged on the backside of the marker for display panel and passes through the slit-shaped opening formed in the marker for display panel, and the light transmitted through the lenticular lens is observed at the observation plane 53. With reference to the light source for alignment, for example, the red light is used for the marker for display panel provided in the upper left and the upper right of the liquid crystal display panel, and the green light is used for the marker for display panel provided in the lower left and the lower right. In the light which has passed through each marker, the traveling direction is changed by the action of the lenticular lens. At this point, when the alignment between the lenticular lens and the liquid crystal display panel is not performed as shown in FIG. 16A, the light 9 which have passed through the opening do not correspond to one another. Therefore, as shown in FIG. 16B, the positions of the lenticular lens and the liquid crystal display panel are aligned so that the light 9 emitted from the light source for alignment correspond to the center line 54 of the observation plane 53. While the light 9 emitted from the light source for alignment correspond to the center line 54 of the observation plane 53, the lenticular lens and the liquid crystal display panel are caused to adhere to each other with the double-sided adhesive tape provided on the lenticular lens to form the three-dimensional image display device.

In the method of manufacturing the three-dimensional image display device 12 of the embodiment, the marker for display panel having the slit-shaped opening is formed in the liquid crystal display panel, and the high-accuracy alignment can be simply performed only with the marker for display panel by utilizing the light passing through the opening of the marker for display panel, so that the general-purpose lenticular lens can be used. As a result, the decrease in production cost and the improvement of the productivity can be realized. Further, the invention can be also applied to the reflective display panel.

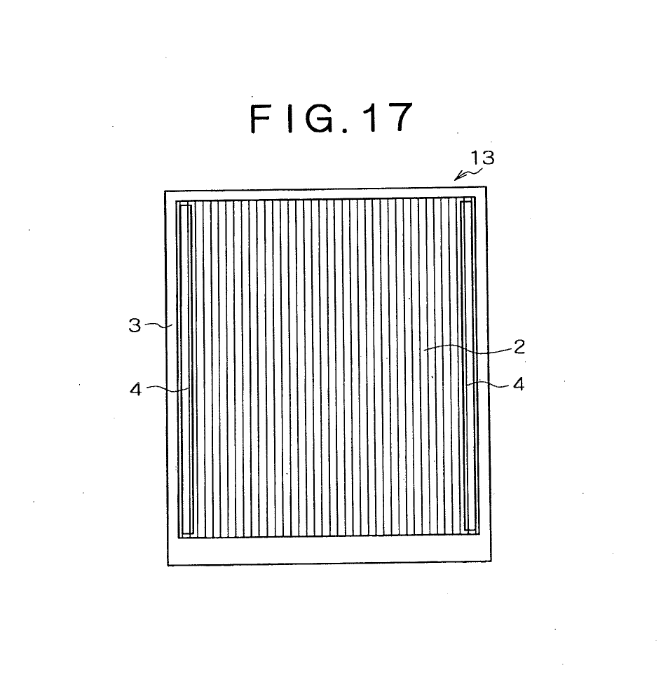

The three-dimensional image display device according to a seventh embodiment of the invention will be described below. FIG. 17 is the top view showing the three-dimensional image display device according to the seventh embodiment of the invention. As shown in FIG. 17, the transmissive liquid crystal display panel 3 and the lenticular lens 2 are provided in a three-dimensional image display device 13 of the embodiment. The lenticular lens 2 is fixed so that the surface in which the cylindrical lens is formed faces the side of the liquid crystal display panel 3. The marker for alignment is not provided in the lenticular lens 2 and the liquid crystal display panel 3. On the backside of the liquid crystal display panel 3, for example, the line sources of light are arranged at the positions, where one of the line sources of light corresponds to the leftmost line in the pixels of the liquid crystal display panel 3 and the other line source of light corresponds to the rightmost line in the pixels of the liquid crystal display panel 3. Further, the line sources of light are arranged so that the longitudinal direction of the line source of light is parallel to the longitudinal direction of the cylindrical lens of the lenticular lens 2.

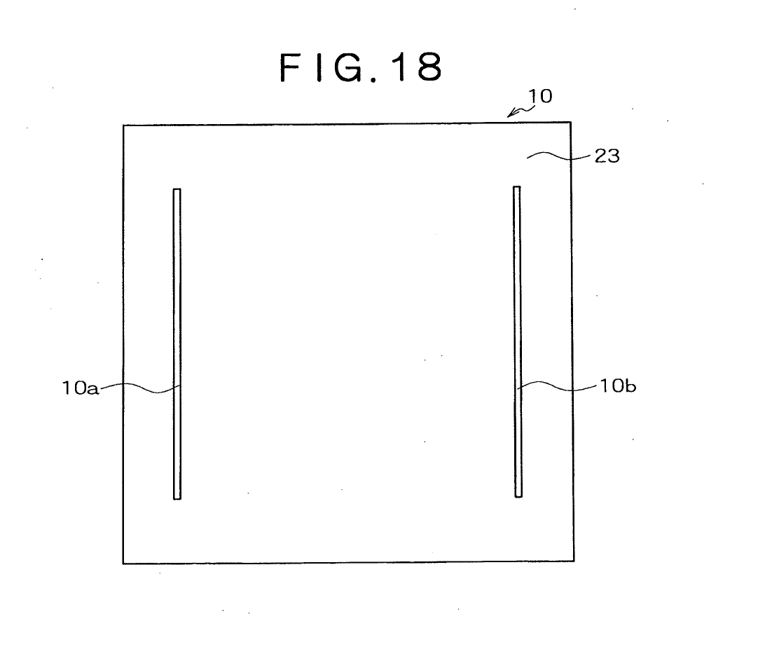

FIG. 18 is the top view showing the light source which is used for the three-dimensional image display device according to the seventh embodiment of the invention. As shown in FIG. 18, in the three-dimensional image display device 13 of the embodiment, the light is emitted from a line source of light 10 in which a light shield 23 is provided into the pixels of one line of the liquid crystal display panel 3, and a pair of slit-shaped openings 10a and 10b parallel to each other is formed in the front surface of the light source (not shown) in the light shield 23. The positions of the lenticular lens 2 and the liquid crystal display panel 3 are aligned with each other by the position where the light is projected on the observation plane through the liquid crystal display panel 3 and the lenticular lens 2. With reference to the light source for alignment, for example, the green light is used for the slit-shaped opening 10a on the left side, and the red light is used for the silt-shaped opening 10b on the right side.

The operation of the three-dimensional image display device 13 of the embodiment, which is configured in the above-described way, will be described below. In the three-dimensional image display device 13 of the embodiment, similarly to the three-dimensional image display devices of the first, third, and fifth embodiments, the traveling directions of the light outgoing from the pixels are changed when the light pass through the lenticular lens 2, and the light outgoing from the pixel for the right eye is incident to the right eye of the viewer while the light outgoing from the pixel for the left eye is incident to the left eye of the viewer. As a result, the light outgoing from the different pixels reach the right and left eyes of the viewer respectively, which allows the viewer to recognize the image displayed on the liquid crystal display panel 3 as the three-dimensional image.

In the three-dimensional image display device 13 of the embodiment, the alignment between the lenticular lens 2 and the liquid crystal display panel 3 can be performed without using the marker for alignment by using the line source of light whose longitudinal direction is parallel to the longitudinal direction of cylindrical lens of the lenticular lens 2, so that the production cost can be decreased.

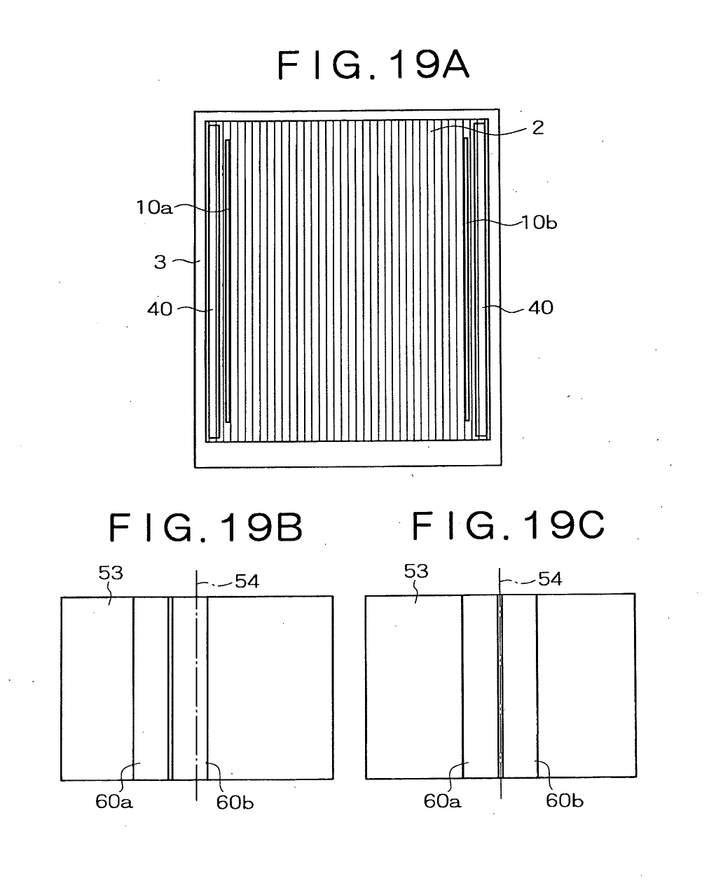

Then, the method of manufacturing the three-dimensional image display device 13 of the seventh embodiment will be described as an eighth embodiment of the invention. FIGS. 19A to 19C are the schematic diagrams showing the method of manufacturing the three-dimensional image display device of the embodiment. At first, for example, the slit-shaped openings 10a and 10b of the line sources of light are arranged at the positions where one of the slit-shaped openings 10a and 10b corresponds to the leftmost line in the pixels of the liquid crystal display panel 3 and the other corresponds to the rightmost line in the pixels of the liquid crystal display panel 3 so that the longitudinal direction of the slit-shaped openings 10a and 10b is parallel to the longitudinal direction of the cylindrical lens in the lenticular lens 2. Then, as shown in FIG. 19A, similarly to the fourth and the sixth embodiments, the double-sided adhesive tape 40 is caused to adhere to the surface of the lenticular lens 2 on the side of the cylindrical lens as the fixing unit. Then, the lenticular lens 2 is brought close to the liquid crystal display panel 3 so that the surface on the side of the cylindrical lens faces the side of the liquid crystal display panel, and the light from the line source of light 10 for alignment is confirmed at the observation plane 53 of the three-dimensional image display device 13. At this point, in the case where the positions of the lenticular lens 2 and the liquid crystal display panel 3 are not aligned with each other, as shown in FIG. 19B, the positions of projection images 60a and 60b from the slit-shaped openings 10a and 10b becomes symmetrical in relation to the center line 54 of the observation plane 53. The projection position of the light from the line source of light 10 depends on the positional relationship between the liquid crystal display panel 3 and the lenticular lens 2. As shown in FIG. 19C, the positions of the lenticular lens 2 and the liquid crystal display panel 3 are adjusted so that the red projection image 60a from the slit-shaped opening 10a on the left side and the green projection image 60b from the slit-shaped opening 10b on the right side are symmetric in relation to the center line 54 of the observation plane 53. While the projection image 60a and the projection image 60b are symmetric in relation to the center line 54, the lenticular lens 2 is fixed to the liquid crystal display panel 3 with the double-sided adhesive tape 40 to form the three-dimensional image display device 13.

In the method of manufacturing the three-dimensional image display device 13 of the embodiment, the high-accuracy alignment can be performed by the simple method, even in the three-dimensional image display device using the general-purpose lenticular lens and the display device in which the marker for alignment is not provided. As a result, the productivity can be improved without increasing the production cost.

Although the three-dimensional image display device in which the lenticular lens is used was described in the embodiment, the manufacturing method is not limited to the lenticular lens, and the manufacturing method can be also applied to the fly-eye lens by using a point source of light instead of the line source of light 10.

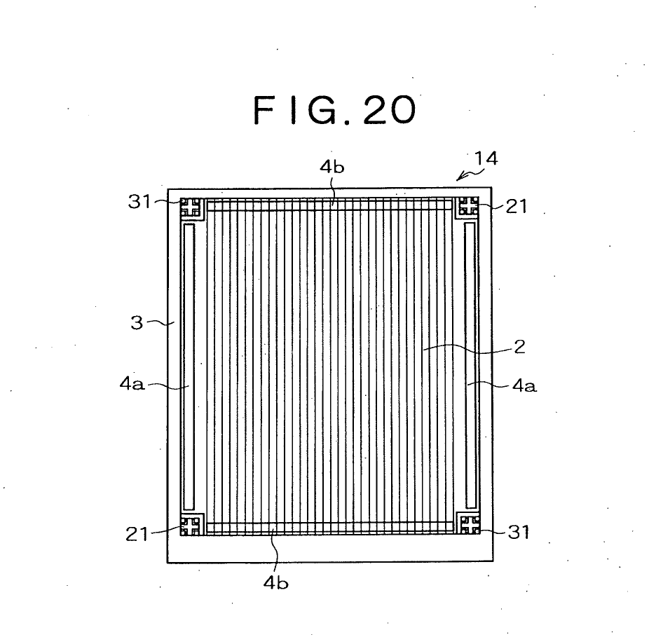

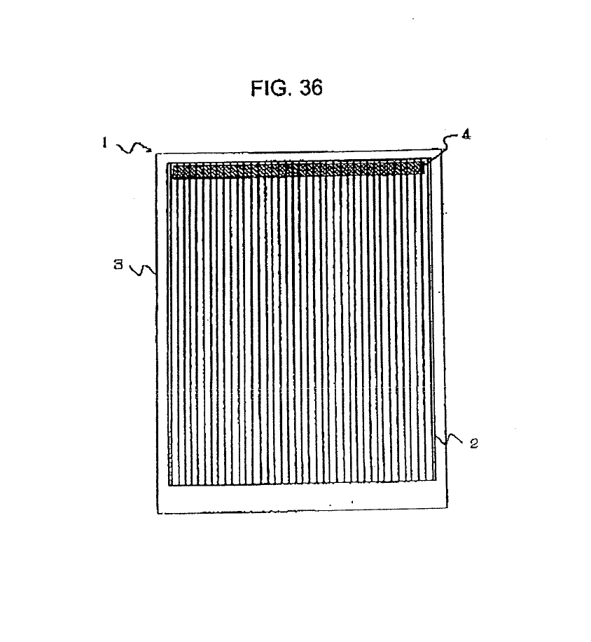

The three-dimensional image display device according to a ninth embodiment of the invention will be described below. FIG. 20 is the top view showing the three-dimensional image display device according to the ninth embodiment of the invention. A three-dimensional image display device 14 of the embodiment is one in which the fixing unit is also provided not only in the longitudinal direction of the cylindrical lens but also in the direction orthogonal to the longitudinal direction of the cylindrical lens. As shown in FIG. 20, the transmissive liquid crystal display panel 3 and the lenticular lens 2 are provided in the three-dimensional image display device 14 of the embodiment. The lenticular lens 2 is fixed to the liquid crystal display panel 3 so that the surface in which the cylindrical lens is formed faces the side of the liquid crystal display panel 3. Similarly to the three-dimensional image display device 1 of the first embodiment shown in FIG. 5, each of the markers 21 for lens having the shape shown in FIG. 8 is provided in the four corners of the lenticular lens 2. Each of the markers 31 for display panel having the shape shown in FIG. 8 is provided at the position where the marker 31 for display panel is matched to the marker 21 for lens of the liquid crystal display panel 3. Fixing unit 4a is provided along the side extending in the longitudinal direction of the cylindrical lens on the side of the cylindrical lens of the lenticular lens 2, and fixing unit 4b is provided along the side extending in the direction orthogonal to the longitudinal direction of the cylindrical lens. FIG. 36 more clearly shows the fixing unit provided along a side extending in a direction orthogonal to the longitudinal direction of the cylindrical lens. With reference to FIG. 36, a three-dimensional image display device 1 is shown having a liquid crystal display panel 3. The lenticular lens 2 has the fixing unit 4 provided along a side in a direction in which the lens is arranged (lateral direction in this figure), i.e. along the upper side in the figure.

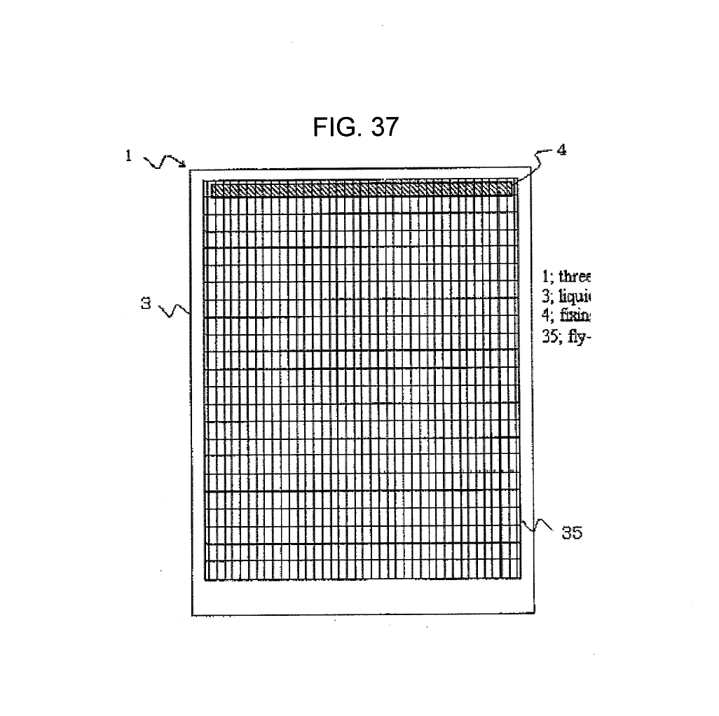

As repeatedly noted above, the three-dimensional image display device is not limited to the lenticular lens, and can also be used with a fly-eye lens. FIG. 37 illustrates a three-dimensional image display device 1 having a liquid crystal display panel 3 where the fixing unit 4 is provided along a side extending in a direction orthogonal to the longitudinal direction of a fly-eye lens 35.

The operation of the three-dimensional image display device 14 of the embodiment, which is configured in the above-described way, will be described below. In the three-dimensional image display device 14 of the embodiment, similarly to the three-dimensional image display device 13 of the seventh embodiment shown in FIG. 18, the traveling directions of the light outgoing from the pixels of the liquid crystal display panel 3 are changed by the lenticular lens 2, and the light outgoing from the pixel for the right eye is incident to the right eye of the viewer while the light outgoing from the pixel for the left eye is incident to the left eye of the viewer. As a result, the light outgoing from the different pixels reach the right and left eyes of the viewer respectively, which allows the viewer to recognize the three-dimensional image.

In the three-dimensional image display device 14 of the embodiment, while maintaining the effect of decreasing the stress applied to the fixing unit when the expansion or the contraction of the lenticular lens 2 and the liquid crystal display panel 3 is caused by the temperature change, the lenticular lens 2 can be securely fixed to the liquid crystal display panel 3 by providing the fixing unit in both the longitudinal direction of the cylindrical lens and the direction orthogonal to the longitudinal direction of the cylindrical lens. As a result, the three-dimensional image display device in which the deterioration caused by the aging is decreased can be realized.

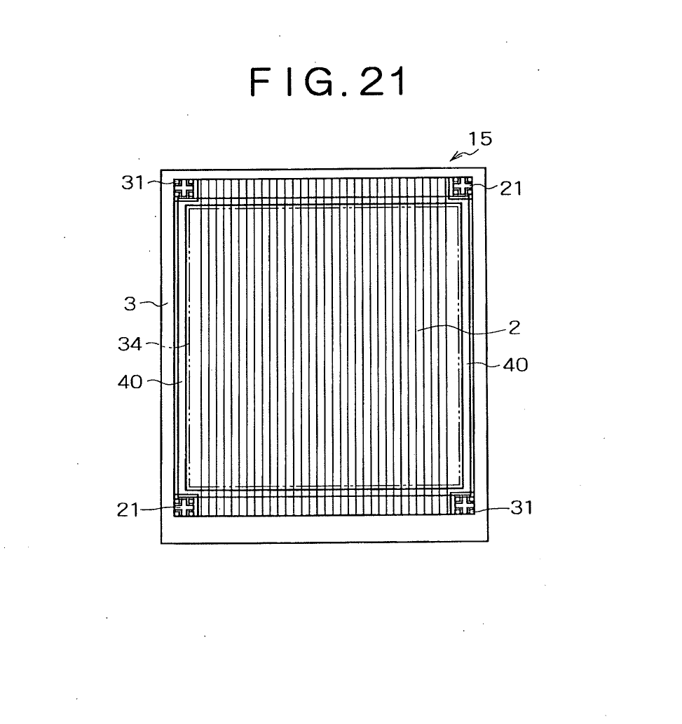

The three-dimensional image display device according to a tenth embodiment of the invention will be described below. FIG. 21 is the top view showing the three-dimensional image display device according to the tenth embodiment of the invention. As shown in FIG. 21, the liquid crystal display panel 3 as the display panel and the lenticular lens 2 as the optical unit are provided in a three-dimensional image display device 15 of the embodiment. The lenticular lens 2 is fixed to the liquid crystal display panel 3 so that the surface in which the cylindrical lens is formed faces the side of the liquid crystal display panel 3. Similarly to the three-dimensional image display device 1 of the first embodiment shown in FIG. 5, each of the markers 21 for lens having the shape shown in FIG. 8 is provided in the four corners of the lenticular lens 2. Each of the markers 31 for display panel having the shape shown in FIG. 8 is provided at the position, where the marker 31 for display panel is matched to the marker 21 for lens, on the upper surface of the liquid crystal display panel 3. In the three-dimensional image display device 15 of the embodiment, the fixing unit 4 is provided so as to enclose an image display surface.

The operation of the three-dimensional image display device 15 of the embodiment, which is configured in the above-described way, will be described below. In the three-dimensional image display device 15 of the embodiment, the traveling directions of the light outgoing from the pixels of the liquid crystal display panel 3 are changed by the lenticular lens 2, and the light outgoing from the different pixels reach the right and left eyes of the viewer respectively. This allows the viewer to recognize the image displayed on the liquid crystal display panel 3 as the three-dimensional image.

In the three-dimensional image display device 15 of the embodiment, the space which is enclosed by the lenticular lens 2, the liquid crystal display panel 3, and the fixing unit 4 can be shielded from ambient atmosphere by providing the fixing unit 4 so that the fixing unit 4 encloses the image display surface 34. As a result, the aging in which the lenticular lens 2 expands by absorbing moisture contained in the ambient atmosphere and the like can be suppressed. Like the three-dimensional image display device 15 of the embodiment, this structure has the larger effect when the surface of the cylindrical lens is arranged on the side of the liquid crystal display panel 3. Since a surface area on the side of the cylindrical lens is larger than the surface area on the side of the flat surface in the lenticular lens 2, the side of the cylindrical lens is easily affected by moisture absorption. In the three-dimensional image display device 15 of the embodiment, the lenticular lens 2 is arranged so that the surface of the cylindrical lens faces the side of the liquid crystal display panel 3, and the surface of the cylindrical lens is shielded from the ambient atmosphere by enclosing a periphery of the surface of the cylindrical lens. This allows the moisture absorption to be prevented on the surface of the cylindrical lens of the lenticular lens 2. As a result, the aging caused by the ambient atmosphere, such as the moisture absorption, can be suppressed while the effect of decreasing the stress applied to the fixing unit is maintained, so that the three-dimensional image display device in which the ageing is decreased and reliability is increased can be realized.

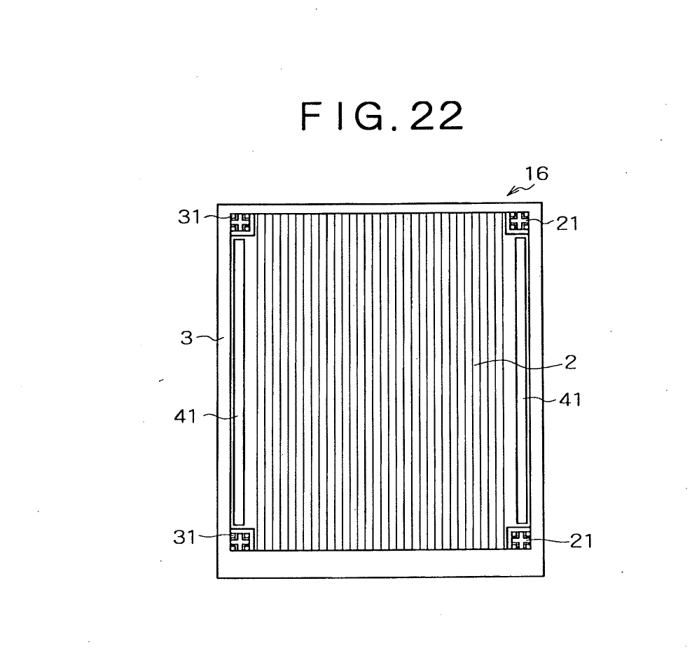

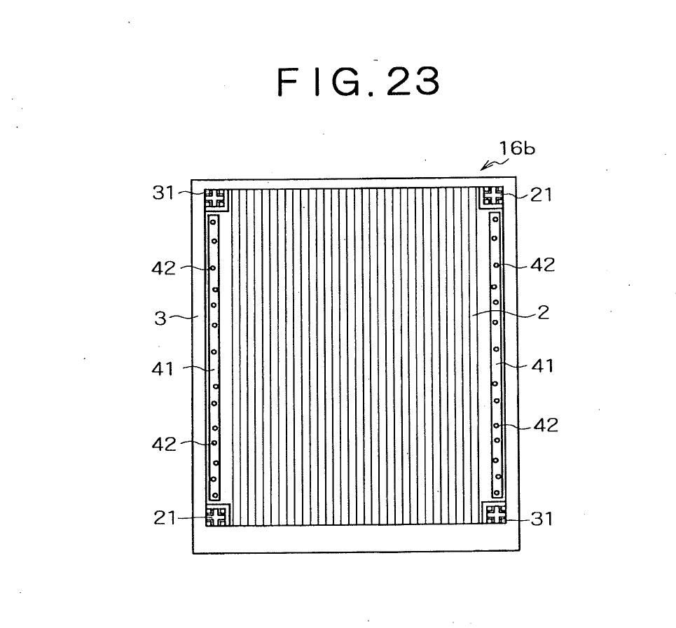

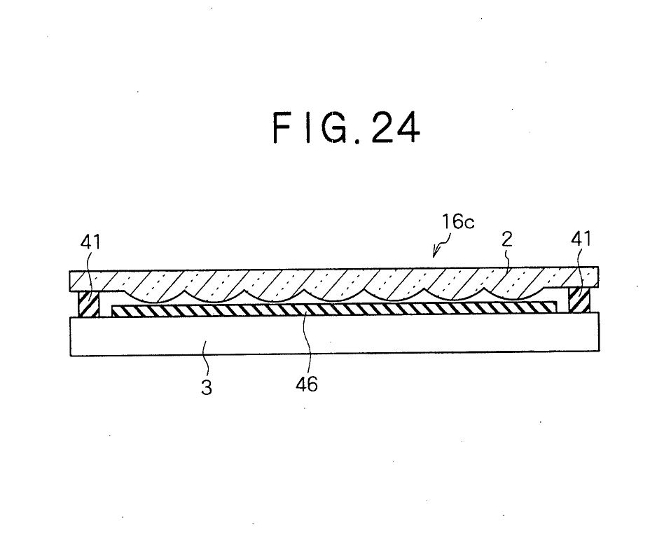

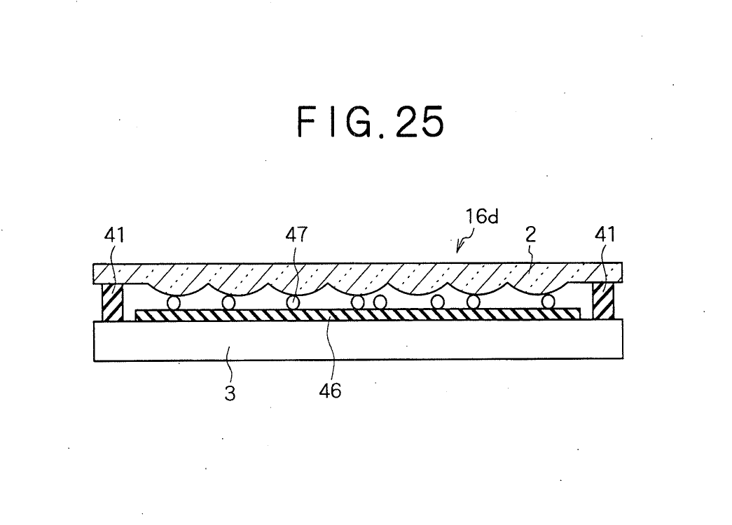

The three-dimensional image display device according to an eleventh embodiment of the invention will be described below. FIG. 22 is the top view showing the three-dimensional image display device according to the eleventh embodiment of the invention, FIG. 23 is the top view showing a first modification of the three-dimensional image display device of the eleventh embodiment, FIG. 24 is the sectional view showing a second modification, and FIG. 25 is the sectional view showing a third modification. As shown in FIG. 22, the liquid crystal display panel 3 and the lenticular lens 2 are provided in a three-dimensional image display device 16 of the embodiment. The lenticular lens 2 is fixed to the liquid crystal display panel 3 so that the surface of the cylindrical lens faces the side of the liquid crystal display panel 3. Each of the markers 21 for lens having the shape shown in FIG. 8 is provided in the four corners of the lenticular lens 2. Each of the markers 31 for display panel is provided in the four corners of the liquid crystal display panel 3. In the lenticular lens 2, the fixing unit is provided along the side extending in the longitudinal direction of the cylindrical lens. In the three-dimensional image display device 16 of the embodiment, an adhesive 41 is used as the fixing unit.

The operation of the three-dimensional image display device 16 of the embodiment, which is configured in the above-described way, will be described below. In the three-dimensional image display device 16 of the embodiment, the traveling directions of the light outgoing from the pixels of the liquid crystal display panel 3 are changed by the lenticular lens 2, and the light outgoing from the different pixels reach the right and left eyes of the viewer respectively. As a result, the viewer recognizes the image displayed on the liquid crystal display panel 3 as the three-dimensional image.

Since the adhesive 41 is used as the fixing unit in the three-dimensional image display device 16 of the embodiment, the positions of the lenticular lens 2 and the liquid crystal display panel 3 can finely adjusted even after the alignment. As a result, the adhesion can be performed with higher accuracy, and production efficiency can be improved. For example, various kinds of photo-setting adhesives such as a twin part adhesive, a thermosetting adhesive, and an ultraviolet curing adhesive, a moisture curing adhesive which is cured by the moisture in the atmosphere, a silicone adhesive, an epoxy adhesive, and the like can be used as the adhesive 41. Particularly, it is preferable to use a visible light-setting adhesive, in which a curing initiator absorbing the light having the wavelength of a visible range is contained and the curing is promoted by irradiation of the visible light. Usually a plastic material having a low transmittance for ultraviolet ray is used as the material of the lenticular lens. Therefore, bonding time can be largely decreased and the productivity can be improved by using the adhesive which is cured with the light having the wavelength of low attenuation in the plastic material.

As shown in FIG. 23, a three-dimensional image display device 16b which is of the first modification of the three-dimensional image display device 16 of the embodiment is one in which fillers 42 are mixed into the adhesive 41 in the three-dimensional image display device 16 shown in FIG. 22. In the three-dimensional image display device 16b, for example, about 2 wt % of the fillers 42 whose average particle size is 50 μm is added to the adhesive 41. The thickness of the fixing unit can be controlled by adding the fillers 42 to the adhesive 41, and the adhesive 41 can be prevented from overflowing onto the display surface of the liquid crystal display panel 3.

As shown in FIG. 24, a three-dimensional image display device 16c which is of the second modification of the three-dimensional image display device 16 of the embodiment is one in which an optical film 46 such as a polarizing plate or a phase difference plate is arranged between the display surface of the liquid crystal display panel 3 and the lenticular lens 2 in the three-dimensional image display device 16b shown in FIG. 23. In the case where the adhesive whose contact angle to the transparent substrate, such as glass, forming the display surface is not lower than 90° is used, the adhesive 41 can be prevented from overflowing onto the display surface by providing the optical film 46 between the display surface of the liquid crystal display panel 3 and the lenticular lens 2.

As shown in FIG. 25, a three-dimensional image display device 16d which is of the third modification of the three-dimensional image display device 16 of the embodiment is one in which gap-holding members 47 are further arranged between the optical film 46 and the lenticular lens 2 in the three-dimensional image display device 16c shown in FIG. 24. Even in the case where the surface of the cylindrical lens of the lenticular lens 2 is arranged on the side of the liquid crystal display panel 3, the spacing between the lenticular lens 2 and the optical film 46 can be held constant by arranging the gap-holding members 47 between the optical film 46 and the lenticular lens 2, and the lenticular lens 2 can be prevented from pushing in the optical film 46.

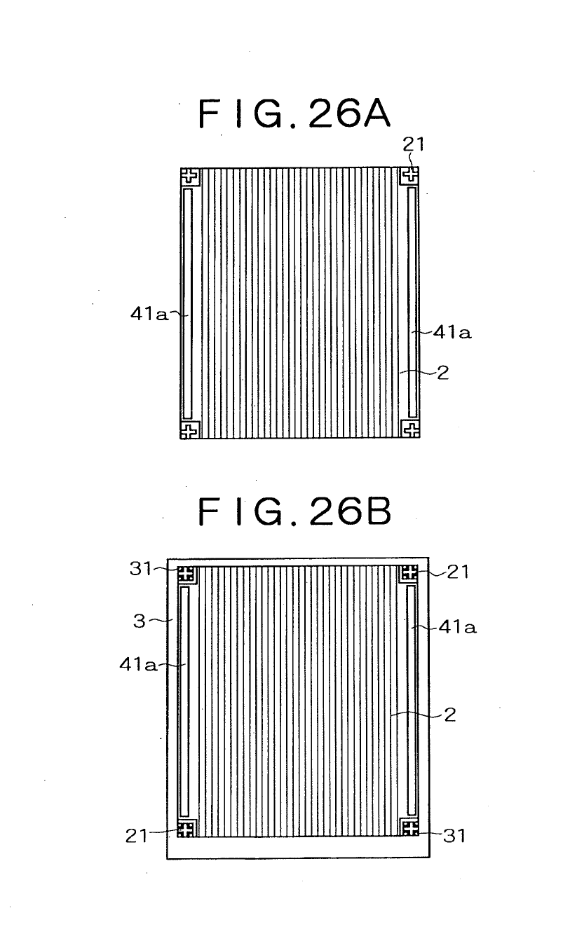

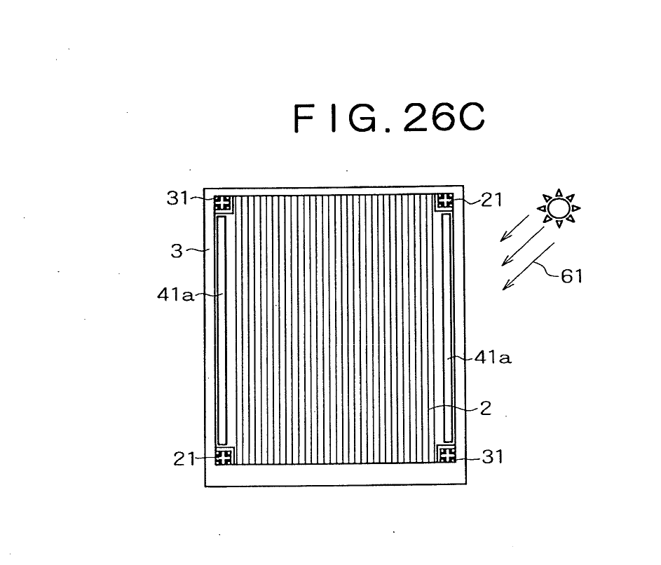

Then, the method of manufacturing the three-dimensional image display device 16 of the eleventh embodiment will be described as a twelfth embodiment of the invention. FIGS. 26A to 26C are the top views showing the method of manufacturing the three-dimensional image display device according to the twelfth embodiment of the invention in order of its process. As shown in FIG. 26A, at first a visible light-setting adhesive 41a is applied in line onto the flat surface of the lenticular lens 2 along the side extending in the longitudinal direction of the cylindrical lens by the usual applying method such as a dispenser method or a printing method. Then, as shown in FIG. 26B, the lenticular lens 2 and the liquid crystal display panel 3 are aligned with each other. At this step, the visible light-setting adhesive 41a is in the liquid state. The relative positional relationship between the lenticular lens 2 and the liquid crystal display panel 3 is finely adjusted to determine a fixed position by aligning the marker 21 for lens with the marker 31 for display panel. Then, as shown in FIG. 26C, the visible light-setting adhesive 41a is cured to fix the lenticular lens 2 to the liquid crystal display panel 3 by irradiating the visible light-setting adhesive 41a with a light 61 having the wavelength which cures the visible light-setting adhesive 41a.

In the three-dimensional image display device 16 of the embodiment which is manufactured by the above-described method, until the visible light-setting adhesive 41a is cured, the positions of the lenticular lens 2 and the liquid crystal display panel 3 can be finely adjusted even after the lenticular lens 2 is arranged on the liquid crystal display panel 3 by using the visible light-setting adhesive 41a. As a result, the adhesion can be performed with higher accuracy, and display quality and the productivity can be improved.

Although the method of applying the adhesive onto the surface of the lenticular lens was described in the embodiment, the invention is not limited to this. It is also possible to apply the adhesive to one of the liquid crystal display panel 3 and the lenticular lens 2, or it is also possible to apply the adhesive to both the liquid crystal display panel 3 and the lenticular lens 2. Although the case in which the visible light-setting adhesive 41a is applied in line was described in the embodiment, the invention is not limited to this case. The visible light-setting adhesive 41a can be applied in broken line within the invention.

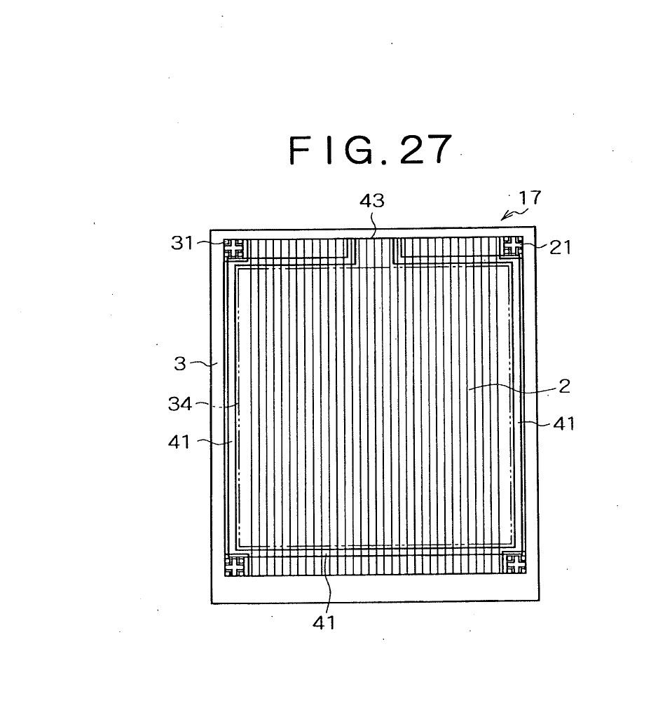

The three-dimensional image display device according to a thirteenth embodiment of the invention will be described below. FIG. 27 is the top view showing the three-dimensional image display device according to the thirteenth embodiment of the invention. The liquid crystal display panel 3 and the lenticular lens 2 are provided in a three-dimensional image display device 17 of the embodiment. The lenticular lens 2 is fixed to the liquid crystal display panel 3 so that the surface of the cylindrical lens faces the side of the liquid crystal display panel 3. Similarly to the three-dimensional image display device 1 of the first embodiment, each of the markers 21 for lens having the shape shown in FIG. 8 is provided in the four corners of the lenticular lens 2, and each of the markers 31 for display panel is provided in the four corners of the liquid crystal display panel 3. The fixing unit including the adhesive 41 is provided so as to enclose the display surface 34 of the liquid crystal display panel 3. However, an opening 43 for expelling the remaining air is provided in a part of the fixing unit.

The operation of the three-dimensional image display device 17 of the embodiment, which is configured in the above-described way, will be described below. In the three-dimensional image display device 17 of the embodiment, the traveling directions of the light outgoing from the pixels of the liquid crystal display panel 3 are changed when the light pass through the lenticular lens 2, and the light outgoing from the different pixels reach the right and left eyes of the viewer respectively. As a result, the viewer recognizes the image displayed on the liquid crystal display panel 3 as the three-dimensional image.

In the three-dimensional image display device 17 of the embodiment, since the adhesive 41 is used as the fixing unit, the space which is enclosed by the lenticular lens 2, the liquid crystal display panel 3, and the adhesive 41 can be completely shielded from the ambient atmosphere. The air which is present in the space enclosed by the lenticular lens 2, the liquid crystal display panel 3, and the adhesive 41 can be expelled through the opening 43. As a result, deformation of the adhesive which is caused by the mixture of an air bubble or the like can be prevented, when the lenticular lens 2 is fixed to the liquid crystal display panel 3.

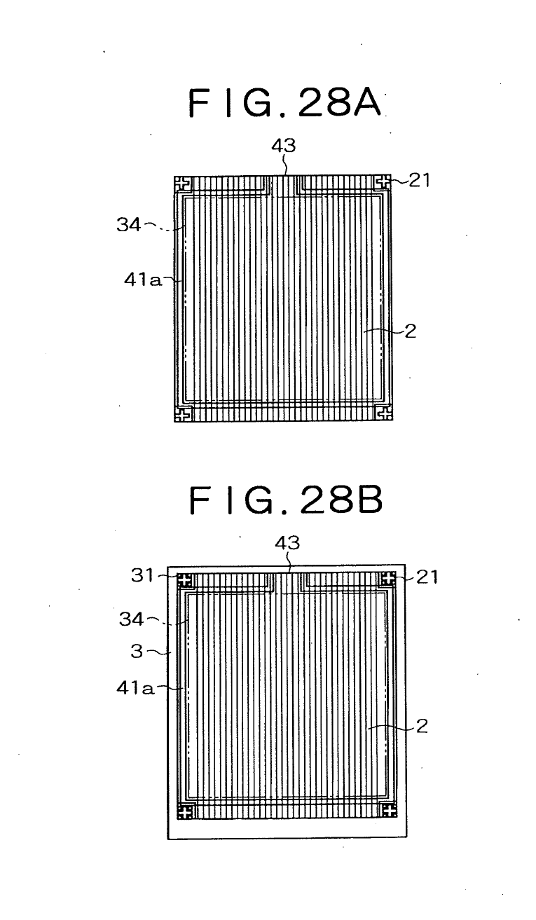

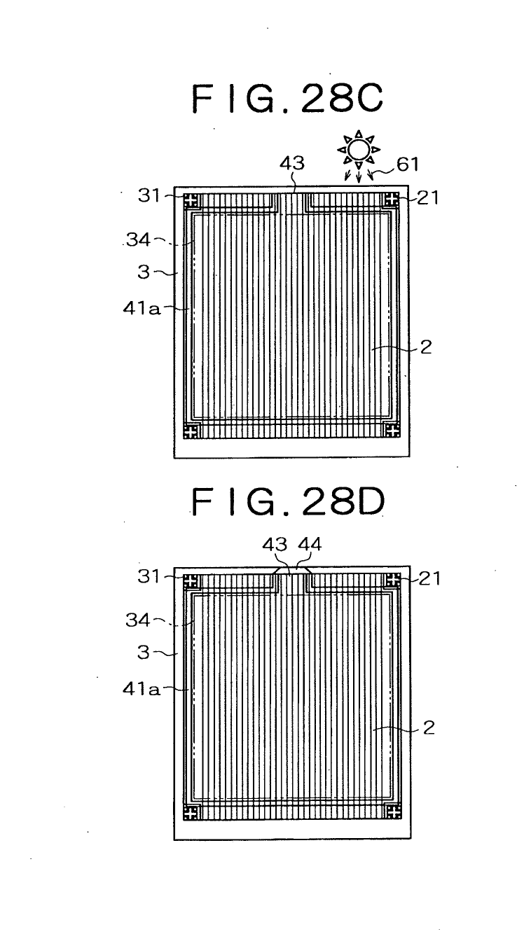

Then, the method of manufacturing the three-dimensional image display device 17 of the thirteenth embodiment will be described as a fourteenth embodiment of the invention. FIGS. 28A to 28D are the top views showing the method of manufacturing the three-dimensional image display device of the embodiment in order of its process. As shown in FIG. 28A, at first the visible light-setting adhesive 41a is applied onto the upper surface of the liquid crystal display panel 3 so as to enclose the display surface 34. At this point, the opening 43 is provided in the fixing unit formed by the visible light-setting adhesive 41a. Then, as shown in FIG. 28B, the lenticular lens 2 is arranged on the liquid crystal display panel 3, and the positions of the lenticular lens 2 and the liquid crystal display panel 3 are finely adjusted by the marker 21 for lens and the marker 31 for display panel. Then, as shown in FIG. 28C, the visible light-setting adhesive 41a is cured to fix the lenticular lens 2 to the liquid crystal display panel 3 by irradiating the visible light-setting adhesive 41a with the light 61 having the wavelength which cures the visible light-setting adhesive 41a. At this point, the air which is excessively present in the space enclosed by the lenticular lens 2, the liquid crystal display panel 3, and the adhesive 41 is expelled through the opening 43. Further, as shown in FIG. 28D, the opening 43 is sealed by a sealer 44. The usual adhesive can be used as the sealer 44.

In the three-dimensional image display device 17 of the embodiment, since the space enclosed by the lenticular lens 2, the liquid crystal display panel 3, and the visible light-setting adhesive 41a can be completely shielded from the ambient atmosphere, the aging can be further decreased. Particularly, this structure has the larger effect when the surface of the cylindrical lens is arranged on the side of the liquid crystal display panel 3. In the three-dimensional image display device 17 of the embodiment, since the visible light-setting adhesive 41a is used, the positions of the lenticular lens 2 and the liquid crystal display panel 3 can be finely adjusted even after the lenticular lens 2 is arranged on the liquid crystal display panel 3, so that the adhesion can be performed with higher accuracy. As a result, the productivity can be improved.

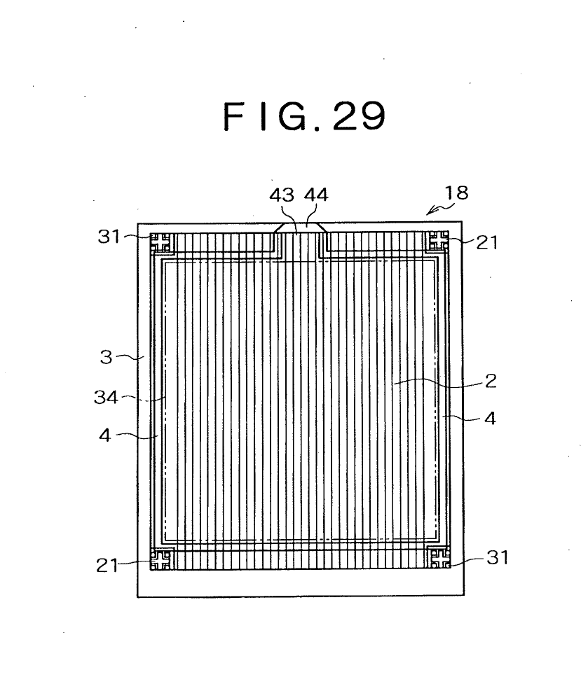

The three-dimensional image display device according to a fifteenth embodiment of the invention will be described below. FIG. 29 is the top view showing the three-dimensional image display device according to the fifteenth embodiment of the invention. Similarly to the three-dimensional image display device 17 of the thirteenth embodiment shown in FIG. 27, the liquid crystal display panel 3 and the lenticular lens 2 are provided in a three-dimensional image display device 18 of the embodiment. The lenticular lens 2 is fixed to the liquid crystal display panel 3 so that the surface of the cylindrical lens faces the side of the liquid crystal display panel 3. Each of the markers 21 for lens having the shape shown in FIG. 8 is provided in the four corners of the lenticular lens 2, and each of the markers 31 for display panel is provided in the four corners of the liquid crystal display panel 3. The fixing unit 4 is provided so as to enclose the display surface 34 of the liquid crystal display panel 3. The opening 43 for expelling the remaining air and the sealer 44 for blocking the opening 43 are provided in a part of the fixing unit 4. Further, in the three-dimensional image display device 18 of the embodiment, the space enclosed by the lenticular lens 2, the liquid crystal display panel 3, and the fixing unit 4 becomes negative pressure.

The operation of the three-dimensional image display device 18 of the embodiment which is configured in the above-described way will be described below. In the three-dimensional image display device 18 of the embodiment, the traveling directions of the light outgoing from the pixels of the liquid crystal display panel 3 are changed when the light pass through the lenticular lens 2, and the light outgoing from the pixel for the right eye is incident to the right eye of the viewer while the light outgoing from the pixel for the left eye is incident to the left eye of the viewer. As a result, the light outgoing from the different pixels reach the right and left eyes of the viewer respectively, which allows the viewer to recognize the image displayed on the liquid crystal display panel 3 as the three-dimensional image.

In the three-dimensional image display device 18 of the embodiment, the space enclosed by the lenticular lens 2, the liquid crystal display panel 3, and the fixing unit 4 is set to the negative pressure than the ambient atmosphere, so that isolation of the lenticular lens 2 caused by the aging can be prevented by atmospheric pressure.

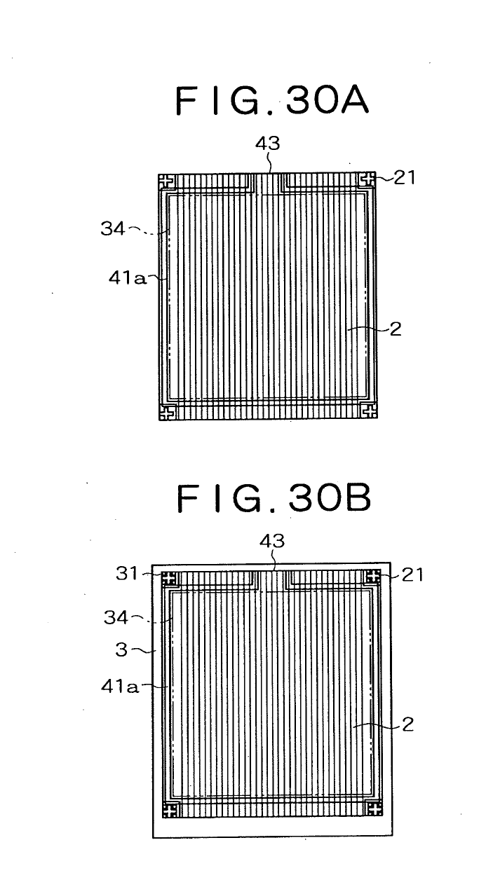

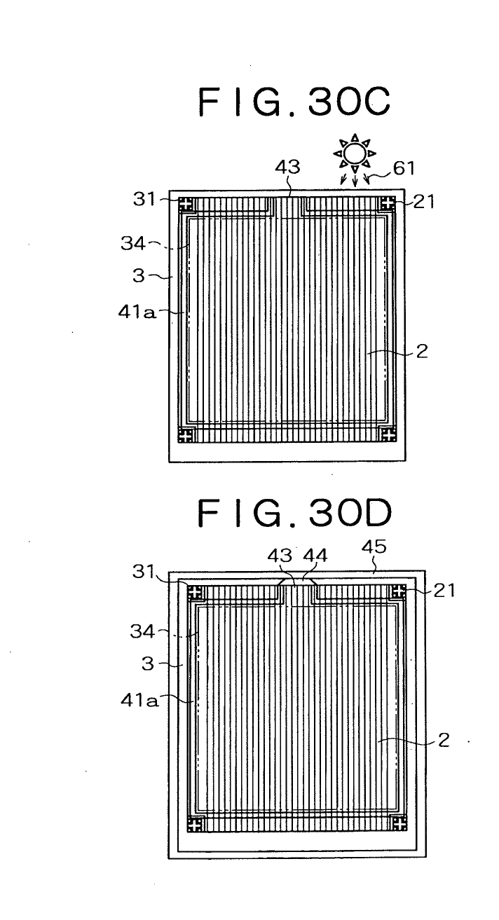

Then, the method of manufacturing the three-dimensional image display device 18 of the fifteenth embodiment will be described as a sixteenth embodiment of the invention. FIGS. 30A to 30D are the top views showing the method of manufacturing the three-dimensional image display device of the embodiment in order of its process. As shown in FIG. 30A, at first the visible light-setting adhesive 41a is applied onto the upper surface of the liquid crystal display panel 3 so as to enclose the display surface 34. At this point, the opening 43 is provided in the fixing unit formed by the visible light-setting adhesive 41a. Then, as shown in FIG. 30B, the lenticular lens 2 is arranged on the liquid crystal display panel 3, and the positions of the lenticular lens 2 and the liquid crystal display panel 3 are finely adjusted by the marker 21 for lens and the marker 31 for display panel. Then, as shown in FIG. 30C, the visible light-setting adhesive 41a is cured to fix the lenticular lens 2 to the liquid crystal display panel 3 by irradiating the visible light-setting adhesive 41a with the light 61 having the wavelength which cures the visible light-setting adhesive 41a. Further, as shown in FIG. 30D, the lenticular lens 2 and the liquid crystal display panel 3 are put into a pressure reducing chamber 45, and the opening 43 is sealed by the sealer 44 under reduced pressure.

In the three-dimensional image display device 18 which is manufactured by the above-described method, since the space enclosed by the lenticular lens 2, the liquid crystal display panel 3, and the visible light-setting adhesive 41a becomes the negative pressure than the ambient atmosphere, the isolation of the lenticular lens 2 can be prevented by the atmospheric pressure, and the high-quality display can be performed for a long time.

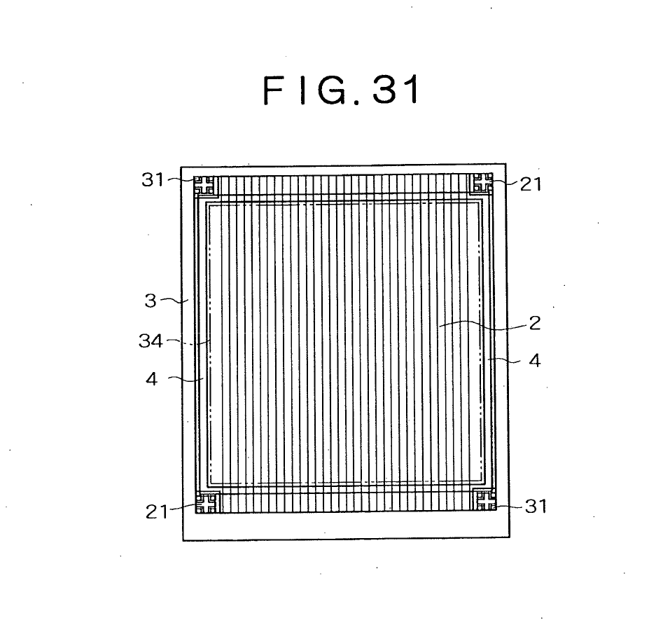

The three-dimensional image display device according to a seventeenth embodiment of the invention will be described below. FIG. 31 is the top view showing the three-dimensional image display device according to the seventeenth embodiment of the invention. As shown in FIG. 31, the liquid crystal display panel 3 as the display panel and the lenticular lens 2 as the optical unit, which is arranged in the surface of the display panel on the side of the viewer 5, are provided in a three-dimensional image display device 19 of the embodiment. Each of the markers 21 for lens shown in FIG. 8 is provided in the four corners of the lenticular lens 2, and the marker 31 for display panel is provided at the position where the marker 31 for display panel is matched to the marker for lens. The fixing unit 4 is formed so as to enclose the display surface 34 of the liquid crystal display panel 3. In the three-dimensional image display device 19 of the embodiment, the opening is not formed in the fixing unit 4, and the display surface 34 is completely enclosed. However, similarly to the three-dimensional image display device 18 of the fifteenth embodiment shown in FIG. 29, the space enclosed by the lenticular lens 2, the liquid crystal display panel 3, and the fixing unit 4 is set to the negative pressure than the ambient atmosphere.

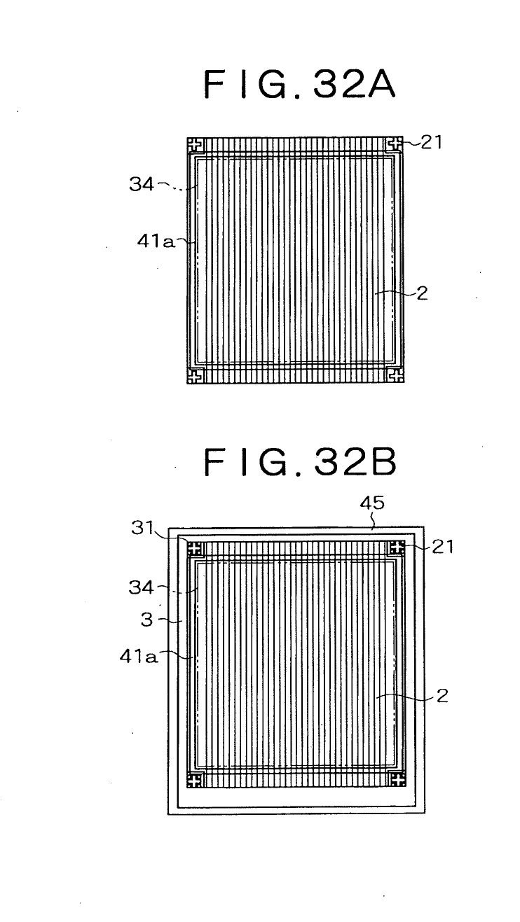

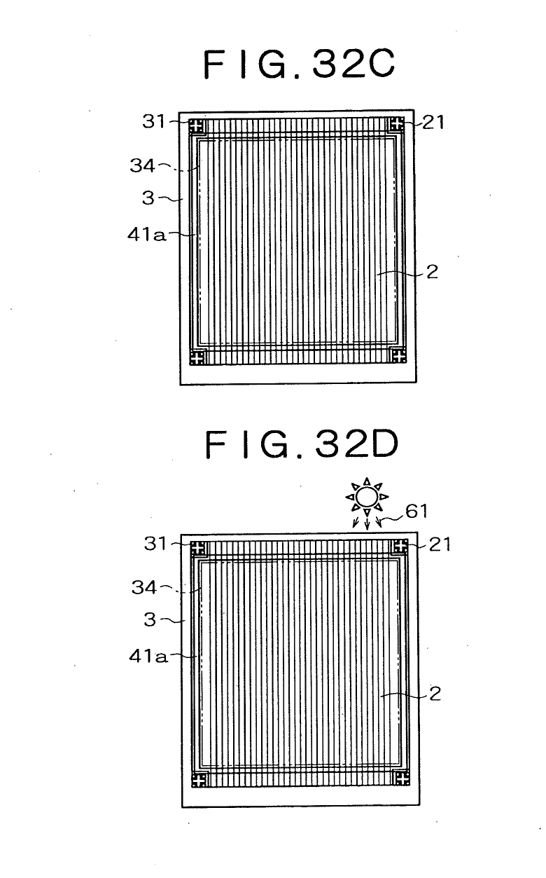

In the three-dimensional image display device 19 of the embodiment, since the space enclosed by the lenticular lens 2, the liquid crystal display panel 3, and the fixing unit 4 becomes the negative pressure than the ambient atmosphere, the isolation of the lenticular lens 2 caused by the aging can be prevented by the atmospheric pressure. Then, the method of manufacturing the three-dimensional image display device 19 of the seventeenth embodiment will be described as an eighteenth embodiment of the invention. FIGS. 32A to 32D are the top view showing the method of manufacturing the three-dimensional image display device of the embodiment in order of its process. As shown in FIG. 32A, at first the visible light-setting adhesive 41a is applied onto the upper surface of the liquid crystal display panel 3 so as to enclose the display surface 34. At this point, the opening is not provided in the fixing unit formed by the visible light-setting adhesive 41a. Then, as shown in FIG. 32B, the lenticular lens 2 and the liquid crystal display panel 3 are put into the pressure reducing chamber 45, and the lenticular lens 2 and the liquid crystal display panel 3 are aligned with each other under reduced pressure. Then, as shown in FIG. 32C, the lenticular lens 2 and the liquid crystal display panel 3 are brought out into the atmosphere while the lenticular lens 2 is arranged on the liquid crystal display panel 3, and the positions of the lenticular lens 2 and the liquid crystal display panel 3 are finely adjusted by the marker 21 for lens and the marker 31 for display panel. As shown in FIG. 32D, the visible light-setting adhesive 41a is cured to fix the lenticular lens 2 to the liquid crystal display panel 3 by irradiating the visible light-setting adhesive 41a with the light 61 having the wavelength which cures the visible light-setting adhesive 41a.

In the three-dimensional image display device 19 which is manufactured by the above-described method, the space enclosed by the lenticular lens 2, the liquid crystal display panel 3, and the visible light-setting adhesive 41a can be set to the negative pressure than the ambient atmosphere without providing the opening 43 by performing the alignment between the lenticular lens 2 and the liquid crystal display panel 3 under reduced pressure. As a result, the manufacturing process can be simplified and the productivity can be improved.

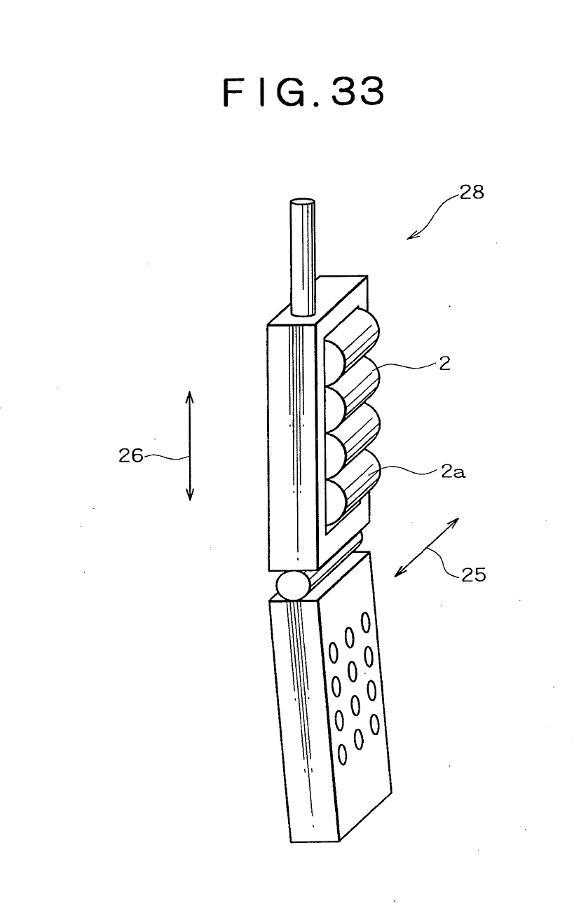

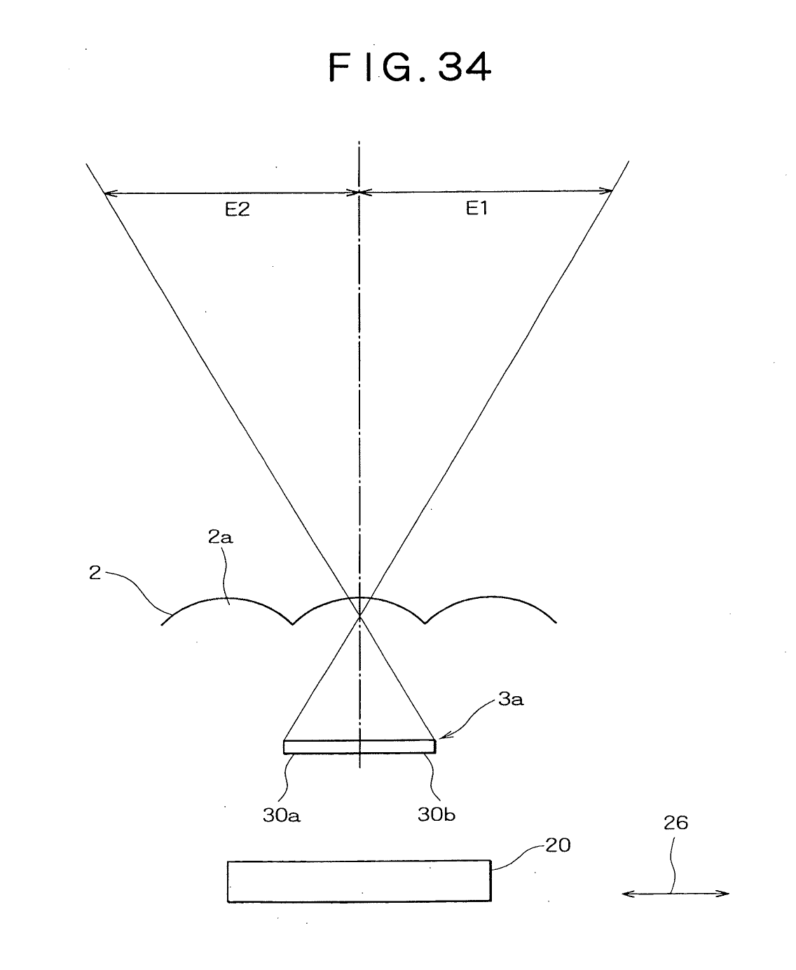

An image display device according to a nineteenth embodiment of the invention will be described below. FIG. 33 is a perspective view showing a portable terminal device in which the image display device of the nineteenth embodiment is mounted, and FIG. 34 is a diagram of the optical model illustrating the operation of the image display device of the embodiment. As shown in FIG. 33, the image display device of the embodiment is mounted in a portable terminal 28. The array direction of cylindrical lenses 2a constituting a lenticular lens 2 is a longitudinal direction 26 and the longitudinal direction of the cylindrical lenses 2a is a lateral direction 25. As shown in FIG. 34, the array direction of a sub pixel 30a for the first viewpoint (hereinafter referred to as “first-viewpoint sub pixel 30a”) and a sub pixel 30b for the second viewpoint (hereinafter referred to as “second-viewpoint sub pixel 30b”) in one display pixel of a display panel 3a is the longitudinal direction 26 which is the same as the array direction of the cylindrical lenses 2a. While FIG. 33 shows only four cylindrical lenses 2a to simplify the illustration, actually there are cylindrical lenses 2a equal in number to the display pixels laid out in the longitudinal direction 26. The other structure of the nineteenth embodiment than those discussed above is the same as that of the image display device of the first embodiment.

The operation of the image display device according to the embodiment will be described below. As shown in FIG. 34, light output from a light source 20 enters the display panel 3a. At this time, lights which have entered the first-viewpoint sub pixel 30a and the second-viewpoint sub pixel 30b of the display panel 3a transmit those pixels and travel toward the lenticular lens 2. Those lights are refracted by the cylindrical lens 2a of the lenticular lens 2 and respectively output toward areas E1 and E2. The areas E1 and E2 are laid out in the lateral direction 25. At this time, when a viewer directs both eyes in the area E1 at this time, the viewer can view the image for the first viewpoint, whereas when the viewer directs both eyes in the area E2, the viewer can view the image for the second viewpoint.

According to the image display device of the nineteenth embodiment, by merely changing the angle of the portable terminal 28, a viewer can direct both eyes to the area E1 or the area E2 to view the image for the first viewpoint or the image for the second viewpoint. In case where the image for the first viewpoint and the image for the second viewpoint have some correlation, particularly, the viewer can view the images by the simple scheme of changing the observation angle, thereby improving the usability considerably. If images for plural viewpoints are laid out in the lateral direction 25, the occur such positions where the right eye and left eye see different images. In this case, the viewer may be confused and cannot identify the images for the individual viewpoints. According to the image display device of the embodiment, by way of contrast, images for plural viewpoints are laid out in the longitudinal direction 26, so that the viewer can always view the images for the individual viewpoints with both eyes and can therefore identify the images easily. The other advantages of the image display device of the embodiment are the same as those of the image display device of the first embodiment. The image display device of the nineteenth embodiment us adaptable to any one of the first to eighteenth embodiments.

What is claimed is:

1. An image display device, comprising:
a display panel which has a plurality of pixel sections each of which includes at least a pixel displaying an image for a first viewpoint and a pixel displaying an image for a second viewpoint, the pixel sections being provided repeatedly; and
an optical unit comprising a plurality of optical elements that refract light emitted from the pixels; wherein
the display panel is provided with a plurality of openings for aligning the display panel with the optical unit, and
when the plurality of openings are illuminated with light from behind, the light passing through each of the plurality of openings corresponds to each other on an observation surface of the image display device.

2. The image display device according to claim 1, wherein when the image display device is planarly viewed, each of the plurality of openings is formed at a position that overlaps with the optical elements.

3. The image display device according to claim, 2, wherein the plurality of openings are slit-shaped openings or pinhole-shaped openings.

4. The image display device according to claim 3, wherein:
the optical unit is disposed such that a surface on which the optical elements are formed faces toward the display panel; and
the optical unit is fixed to the display panel via an adhesive material directly provided on the optical unit.

5. The image display device according to claim 1, wherein the light passed through each of the plurality of openings correspond to each other in a central line of the observation surface.

6. The image display device according to claim 1, wherein:
the optical unit is a lenticular lens comprising a plurality of semi-cylindrical lenses that serve as the plurality of optical elements; and
the plurality of openings are slit-shaped openings.

7. The image display device according to claim 6, wherein
the slit-shaped openings are formed at four colliers of the display panel.

8. The image display device according to claim 1, wherein
the optical unit is a fly-eye lens comprising a plurality of convex lenses that serve as the plurality of the optical elements, and
the plurality of openings are pinhole-shaped openings.
